(19) United States
(12) Patent Application Publication
(10) Pub. No.: US 2010/0055658 A1
(43) Pub. Date: Mar. 4, 2010

(54) SYSTEM FOR AND METHOD FOR PSYCHOLOGICAL ASSESSMENT

(75) Inventors: W. Michael Sturm, Santa Cruz, CA (US); Edward M. Yokley, Pembroke Pines, FL (US); Melissa Meredith Wells, Boston, MA (US); Bruce Holt, Colebrook, NH (US); John Murphy, Centerville, MA (US)

Correspondence Address: FOLEY & LARDNER LLP, P.O. BOX 80278, SAN DIEGO, CA, 92138-0278, US

(73) Assignee: Spherical Dynamics Inc

(21) Appl. No.: 12/282,858

(22) PCT Filed: Mar. 13, 2007
(86) PCT No.: PCT/US07/06398

§ 371 Date: Oct. 8, 2009

(30) Foreign Application Priority Data
Feb. 26, 2002 (US) PCT/US02/06009

(51) Int. Cl. G09B 7/00

(52) U.S. Cl. 434/350; 434/362

(57) ABSTRACT

In systems, methods and program products relating to the assessment of individuals, a subject can be provided with an assessment through software and a computer for improved functionality. The software may be directly installed on the subject's computer or may be on a remote server accessible through a communication network, such as a local network or the Internet. Stimuli to be presented to subject are selected in real time and may be selected randomly from a database of stimuli. Further, in the event of borderline cases, a refinement process may be used to provide an accurate assessment of the subject. Methods for the assessment of teams, comprising subject individuals, for the construction of ideal process profiles, and for coaching individuals are provided.

### FIELD OF THE INVENTION

The present invention relates generally to the field of psychological assessment of individuals and teams of individuals.

### BACKGROUND OF THE INVENTION

Much time and effort is expended in the practical application of various psychological instruments in efforts to determine reproducible methods of assessing how individuals and groups of individuals (e.g., teams) make decisions, learn, and accomplish tasks. Conventional assessments require that an individual endure a lengthy evaluation which requires complex processing to determine a personality, knowledge or other type of assessment. Such conventional assessments are typically administered by a psychometrist following a predetermined set of stimuli, and seek to describe psychological characteristics of the individual.

### SUMMARY OF THE INVENTION

The present invention provides systems, methods and program products relating to the assessment, evaluation, training and coaching of subjects such as individuals, groups of individuals, and entities.

All of the terms in this summary are elaborated below. The invention provides a variety of descriptions of an individual based on the strengths and weaknesses (i.e., energy) of the individual as measured in discrete psychological categories. In some instances, there are four categories, e.g., strategize, motivate, analyze, and active. These categories have multiple names in the art. The starting point for the descriptions is an assessment, which determines the strength of the individual in each of the psychological categories. In some instances, the energy is represented by a numerical value, with a larger numerical value corresponding to a greater energy. In other instances, the strength is represented by an ordering of the categories, for example from “least like” to “most like.” The numbers representing the strengths of the individual when taken together can form a process map, which maps out the processes that the individual uses to complete a task. In some instances, the energy of each category can be determined by presenting the individual with a series of plurality of stimuli (e.g., pairs of words) which have been found to correspond to the categories, and asking the individual to choose one stimulus from among the plurality of stimuli. Based on the responses of the individual, the assessment can be constructed. In some instances, based on the relative strengths represented in the assessment, specific evaluations which include narrative descriptions of the individual can be created. These narrative descriptions can include how the individual prefers to work, learn, and work with others. The concept of an assessment can be further expanded to embrace a virtual (i.e., ideal) individual that would be best suited to perform a task, and based on a comparison of the virtual and individual assessments, a narrative description of how well an individual would perform a specific task can be constructed. In some instances, an assessment describing a team of individuals can be created by overlaying the individual assessments of the team members, for example. Furthermore, assessments can be compared between individuals to determine how best the individuals can work together, and based on the resulting assessment, a description of how the individuals work together can be constructed. Furthermore, the assessments, and the narrative description based on them, can be used to coach an individual to better perform a task.

In a first aspect, the invention provides a method of conducting an assessment of a subject comprising: a) presenting to the subject a first set of two or more stimuli, for example two, three, four or more stimuli, wherein at least two of the stimuli correspond to different characteristic categories; and, b) receiving a selection by the subject of one of the stimuli corresponding to a first characteristic category. The term “assessment” refers to an evaluation, a categorization or other determination of a subject, such as an individual. An assessment may include characteristic categories describing the subject. Furthermore, an assessment may include a psychological assessment. A “subject” may be an individual, a group of individuals or an entity, for example, a team. In particular embodiments, an assessment includes stimuli selected by the subject. The terms “presentation” or “presenting” refer to displaying as graphics, text, audio, video, or the like. A display may include the use of computer or other electronic device and may be accomplished through a communication network, such as the Internet. The term “stimulus” refers to a word-pair or other device, such as photo, image, graphic, sketch, or the like, selected to elicit a response from the subject. The term “word-pair” refers to two words or phrases taken together. In one embodiment, the separate words or phrases of a word-pair are separated by a comma. Non-limiting examples of word-pairs include the following: “aggressive, boisterous,” “well prepared, conceptual,” “self disciplined, firm,” “explores options, sensitive.” The term “characteristic category” refers to a characteristic, a phase or other feature of a subject or an assessment. Each characteristic category may correspond to a characteristic or feature associated with an emotional, physical, biological or intelligence characteristic, for example. The term “receiving” refers to acquiring a signal or an input, for example. The term “receiving a selection” refers to acquiring or otherwise accepting as input from the subject an indication in the form of a response choosing one of the stimuli in preference to other stimuli. In certain embodiments, receiving includes a response time criterion (i.e., time limit for response) beyond which a response is not accepted. The term “response time criterion” refers to an interval of time after presentation of a stimulus that a subject is allotted for providing a response. The response time criterion can be for example 1, 2, 3, 4, 5, 10, 15, 20, 30, 45 seconds, 1, 2, 3, 4, 5 minutes, or even longer. In some embodiments, the response time criterion is in the range 1-10, 1-20, 1-30, and 1-45 seconds. In preferred embodiments, the response time criterion is in the range 1-45 seconds. In certain embodiments, if a response is not accepted then the method returns to the previous step. In certain embodiments, receiving includes recording the time taken by the subject to respond to each of a plurality of stimuli and using a response time consistency criterion calculated from a statistical analysis of the elapsed time so recorded. “Response time consistency criterion” refers to a statistical factor which is calculated from the time taken by a subject in responding to each of a plurality of stimuli. If a response is not received within the response time consistency criterion, then the response is discarded. Optionally, the subject may be presented an additional stimulus. In some embodiments, a response time consistency criterion is a multiple of the average time required by the subject to respond to a plurality of stimuli. In some embodiments, the multiple of the average time is in the range 0.01 to 100 (e.g., 0.1 to 10, 0.1 to 5, and the like). For example without limitation, if the average time taken by a subject to respond to a stimuli were 10-sec, the response time consistency criterion can be a multiple thereof(e.g., 1, 2, 3, 4, 5, 10, 15, 20, 30, 40, 50, 60, 70, 80, 90, 100, or even 1000 sec). In some embodiments, the response time consistency criterion is calculated by adding a multiple of the standard deviation of the response time for a plurality of stimuli to the average time taken to respond to the plurality of stimuli. In some embodiments, the multiple is in the range 0.01 to 100, e.g., 0.1, 1, 2, 3, 4, 5, 6, 7, 8, 9, 10, 15, 20, 30, 40, 50, or even 100). For example without limitation, if the average time to respond were 10 sec, and the standard deviation of the response times were 3-sec, the response time consistency criterion could be 10-sec plus some multiple of 3-sec., providing a time consistency criterion of 13-sec, 16-sec, 19-sec, 22-sec, 25-sec, for multiples of 1-5, respectively). The term “response” refers to an indication of a preference or a selection by the subject. The response may be “yes” or “no,” a number between two extremes, for example, without limitation, 1-2, 1-3, 1-5, 1-10, 1-100, or a selection of one option from a plurality of options. Furthermore, the response may be selection or non-selection by the subject. The term “first characteristic category” refers to the characteristic category corresponding to the first stimulus selected by the subject (i.e., step b).)

In preferred embodiments, three or four or more stimuli are presented in step a), or four stimuli are presented in step a) wherein each characteristic category corresponds to a different phase in a success/satisfaction cycle. The terms “phase,” “phase in a success/satisfaction cycle,” and “success/satisfaction cycle” are elaborated below.

In other preferred embodiments, an inquiry is presented to the subject in step a), and the selection received in step b) is in response to the inquiry. The terms “inquiry” and “query” refer to a solicitation for a response, for example, a question presented to the subject. Accordingly, the subject may be asked to respond to the stimuli to indicate a preference or a selection. In some embodiments, the requested response may be either “yes” or “no” to a query such as “DOES THIS OBJECT DESCRIBE YOU?” In other embodiments, the requested response may be a number between two extremes, for example, 1-2, 1-3, 1-5, 1-10, 1-100. For example, the query may be “ON A SCALE OF 1 TO 10, WHAT IS THE LEVEL AT WHICH THIS OBJECT DESCRIBES YOU?” In still another embodiment, the query may ask the subject to select an option from a plurality of options. For example, the query may be “PLEASE SELECT ONE OF THE FOLLOWING TO INDICATE HOW WELL THIS OBJECT DESCRIBES YOU,” and the subject may be presented with two or more options, for example: “STRONGLY AGREE,” “AGREE,” “NEUTRAL,” “DISAGREE,” and “STRONGLY DISAGREE.” The term “OBJECT” in this context refers to a presented stimulus.

In yet other embodiments, the method includes the following steps: c) presenting to the subject a second set of two or more stimuli corresponding to characteristic categories different from the first characteristic category; and d) receiving a selection from the subject of one of the second set of two or more stimuli corresponding to a second characteristic category. The term “second characteristic category” refers to the characteristic category corresponding to the stimulus selected by the subject in step d).

In still other embodiments, the method further includes the following steps: e) presenting to the subject a third set of two or more stimuli corresponding to characteristic categories different from the first and second characteristic categories; and f) receiving a selection by the subject of one of the third set of two or more stimuli corresponding to a third characteristic category. The term “third characteristic category” refers to the characteristic category corresponding to the stimulus selected by the subject in step f).

In other embodiments, the method further includes obtaining an order of selection of the characteristic categories. In yet other embodiments, the characteristic categories are the first, second, and third characteristic categories corresponding to the selections made in steps b), d) and f), in combination with any characteristic categories not selected in steps b), d) or f). The terms “order of selection” and “stack order” refer to an ordering according to rank and is synonymous with the term “rank order” in the usual statistical sense. The term “rank” refers to a preference, for example, without limitation, “most like” through “least like.” Accordingly, an order of selection may indicate a hierarchical relationship of selected characteristic categories of the subject.

In yet other embodiments, the method is repeated (i.e., steps a) through f)) with additional sets of stimuli. The additional sets of stimuli may include stimuli not previously presented to the subject. In other embodiments, the stimuli are selected for presentation at random from a database of stimuli. The term “random” refers to an equal probability of selection among a plurality of possibilities, e.g., equal probability of selection of any possible stimulus from a plurality of stimuli. In contrast, the terms “non-random” and “partially random” refer to an unequal probability of selection of any one or more possible selections from a plurality of possible selections. The term “database of stimuli” refers to a computer database which contains entries of stimuli comprising graphics, text, audio, video, or the like. The entries in the database of stimuli may be referenced by characteristic category. In particular embodiments, the stimuli in the database of stimuli are text. In other particular embodiments, the stimuli in the database of stimuli are word-pairs. In other embodiments, steps a) to c) include communication with the subject through a network. The network may be the Internet. In yet other embodiments, each stimulus is a word-pair.

A further aspect of the invention relates to a method of conducting an assessment of a subject and comprises: a) presenting to the subject two to four stimuli, for example two, three, or four stimuli, and an inquiry, each stimulus corresponding to a phase in a success/satisfaction cycle; b) receiving a selection by the subject of one of the stimuli in response to the inquiry; and c) repeating steps a) and b) until an order of selection of each phase in a success/satisfaction cycle is determined. The terms “phase in a success/satisfaction cycle” and “success/satisfaction cycle” are elaborated below. In preferred embodiments, the method further includes step d), processing the order of selection to determine an assessment of the individual. The term “processing the order of selection” refers to providing an assessment based on the hierarchical order of the phases in a success/satisfaction cycle. In preferred embodiments, each stimulus of the method is a word-pair. In certain embodiments, receiving further includes a response time criterion beyond which a response is not accepted. In certain embodiments, if a response is not accepted then the method returns to the previous step. In preferred embodiments, the response time criterion is in the range 1-45 seconds. In certain embodiments, receiving further includes recording the time required to respond to each of a plurality of stimuli, and calculating a response time consistency criterion, as described herein, which determines whether a particular response is accepted. If a response is not received within the response time consistency criterion, then the response is discarded. Optionally, the subject may be presented an additional stimulus. In some embodiments, a response time consistency criterion is a multiple of the average time required by the subject to respond to a plurality of stimuli. In some embodiments, the multiple of the average time is in the range 0.01 to 100 (e.g., 0.1 to 10, 0.1 to 5, and the like). For example without limitation, if the average time taken by a subject to respond to a stimuli were 10-sec, the response time consistency criterion can be a multiple thereof (e.g., 1, 2, 3, 4, 5, 10, 15, 20, 30, 40, 50, 60, 70, 80, 90, 100 sec, or even longer).

In another aspect, the invention provides a program product. The program product comprises machine readable program code for causing a machine to perform the following method steps: a) presenting to the subject a first set of two or more stimuli, for example two, three, four or more stimuli, wherein at least two of the stimuli correspond to different characteristic categories; and, b) receiving a selection by the subject of one of the stimuli corresponding to a first characteristic category.

In preferred embodiments, the program product further includes machine readable program code for causing a machine to present four stimuli in step a), wherein each different characteristic category corresponds to a different phase in a success/satisfaction cycle, as elaborated below. In other embodiments, the program product further includes machine readable program code for causing a machine to present an inquiry to the subject in step a) and receive a selection by the subject in response to the inquiry in step b). In other embodiments, the program product further includes machine readable program code for causing a machine to c) present to the subject a second set of two or more stimuli corresponding to characteristic categories different from the first characteristic category; and d) receive a selection from the subject of one of the second set of two or more stimuli corresponding to a second characteristic category. In yet other embodiments, the program product further includes machine readable program code for causing a machine to e) present to the subject a third set of two or more stimuli corresponding to characteristic categories different from the first and second characteristic categories; and f) receive a selection by the subject of one of the third set of two or more stimuli corresponding to a third characteristic category. In other embodiments, the program product further includes machine readable program code for causing a machine to obtain an order of selection of the characteristic categories. In other embodiments, the program product further includes machine readable program code for causing a machine to repeat steps a) through f) with additional sets of stimuli. In still other embodiments, steps a) to b) further include communication with the subject through a network. In particular embodiments, this network is the Internet. In other embodiments, each stimulus of the program product includes a word-pair. Further this aspect, any embodiment can further include machine readable program code for causing a machine to calculate and use a response time criterion or response time consistency criterion, as described herein.

In another aspect, the invention provides a program product comprising machine readable program code for causing a machine to perform the following method steps: a) presenting to the subject two to four stimuli, for example two, three, or four stimuli, and an inquiry, each stimulus corresponding to a phase in a success/satisfaction cycle; b) receiving a selection by the subject of one of the stimuli in response to the inquiry; and c) repeating steps a) and b) until an order of selection of each phase in a success/satisfaction cycle is determined. In preferred embodiments, the program product includes machine readable program code for causing a machine to perform the following method step: d) processing the order of selection to determine an assessment of the subject. In other embodiments, each stimulus of the program product includes a word-pair. Further this aspect, any embodiment can further include machine readable program code for causing a machine to calculate and use a response time criterion or response time consistency criterion, as described herein.

In another aspect of the invention, a system is provided for conducting an assessment of a subject, which system comprises a server adapted to present two or more stimuli to the subject on a computer, each stimulus corresponding to a different characteristic category, wherein the server is further adapted to receive a selection by the subject of one of the stimuli. A “server” may include a computer or a computing device provided with software to allow the computer or computing device to communicate with another computer or computing device in a server-client relationship as understood by one of skill in the art. In other embodiments of the system, each stimulus includes a word-pair.

In another aspect, a computer-implemented method of evaluating an assessment of a subject is provided which comprises: a) presenting to a subject at least one stimulus, for example one, two, three, four, or more stimuli, wherein at least one stimulus is selected in real time and corresponds to a characteristic category; and b) evaluating an assessment of the subject based on a response received from the subject to each stimulus presented. The term “evaluating an assessment” refers to assigning numeric value scores to the characteristic categories of an assessment. The numeric value scores may be the sum of weighted stimulus scores corresponding to particular stimuli. The term “weighted stimulus score” refers to a number in the range 1-100, for example without limitation, 1, 2, 3, 4, 5, 6, 7, 8, 9, 10, 20, 30, 40, 50, 100, associated with each stimulus. The weighted stimulus score may be associated with a stimulus in a database of stimuli by methods commonly known in the art. Specific examples of weighted stimulus scores associated with particular stimuli are provided herein, for example, FIG. 6. The term “response received from the subject” refers to a selection of one or more of the stimuli presented in step a). In certain embodiments, the subject has a time limit (i.e., response time criterion) within which to respond, after which the response is not accepted. In certain embodiments, if a response is not accepted then the method returns to the previous step. In preferred embodiments, the response time criterion is in the range 1-45 seconds. In certain embodiments, receiving includes recording the time taken by the subject to respond to each of a plurality of stimuli, and using a response time consistency criterion calculated from a statistical analysis of the elapsed time so recorded. “If a response is not received within the response time consistency criterion, then the response is discarded. Optionally, the subject may be presented an additional stimulus. In some embodiments, a response time consistency criterion is a multiple of the average time required by the subject to respond to a plurality of stimuli, as described herein. In some embodiments, the multiple is in the range 0.1 to 10. The term “real time” refers to the time period during which the assessment is conducted. Real time may include delays associated with processing, communicating or accessing data or devices, for example. “Real time” may be less than one microsecond, less than ten microseconds, less than one second, less than ten seconds, less than one minute or less than 10 minutes before the presentation of the stimulus to the subject. In preferred embodiments, step a) further includes randomly selecting at least one stimulus from a database of stimuli. The term “selecting” refers to choosing, picking or singling out one or more stimuli from a list, table or database, for example. In other preferred embodiments, each stimulus is a word-pair. In other embodiments, step a) further includes formulating an entire assessment by presenting a plurality of stimuli to a subject. The term “formulating” refers to selection of an entire set of stimuli to be presented to the subject for an assessment. In particular embodiments, the plurality of stimuli may include at least one stimulus corresponding to each of a plurality of different characteristic categories. In other embodiments, the method further includes: c) determining whether the assessment evaluated in step b) requires refinement between two or more characteristic categories. The term “refinement” refers to a discrimination process required in borderline instances. The term “borderline” refers to the case wherein the difference in the numeric value scores of two categories is not greater than a required minimum. The terms “required minimum” and “refinement criterion” refer to a number, for example, 1, 2, 3, 4, 5, or greater. For example, if the numeric value scores of two characteristic categories were less than 3, and the required minimum were 4, refinement would be necessary. In other embodiments, the method includes the following step: d) presenting an additional stimulus corresponding to each of the two or more characteristic categories. Other embodiments include: e) repeating steps b) through d) until a desired level of refinement is achieved. The term “desired level of refinement” refers to the required minimum in the difference in the numeric value scores of two categories of the assessment, as elaborated above. In other embodiments of this aspect, the method further includes the following steps: d) presenting to the subject two or more stimuli, wherein each stimulus corresponds to a different characteristic category; e) receiving a selection by the subject of one of the stimuli; and f) repeating steps d) and e) to obtain an order of selection of each different characteristic categories. In yet other embodiments, the method further includes: g) repeating steps c) to f) until a desired level of refinement is achieved.

In another aspect, the invention provides a program product. The program product comprises machine readable program code for causing a machine to perform the following method steps: a) presenting, when an assessment of a subject requires refinement between two or more characteristic categories of the assessment, to a subject a first set of three or more stimuli, wherein each stimulus in the first set of three or more stimuli corresponds to a different characteristic category; b) receiving a selection by the subject of one of the stimuli; c) presenting to the subject a second set of two or more stimuli, wherein each stimulus of the second set of two or more stimuli corresponds to a different characteristic category; and d) repeating steps b) and c) to obtain an order of selection of each of the different characteristic categories. Further this aspect, any embodiment can further include machine readable program code for causing a machine to calculate and use a response time criterion or response time consistency criterion, as described herein.

In another aspect, the invention provides a method of conducting an assessment of a team comprised of members, comprising the following steps: a) providing the process maps of the members of the team; b) overlaying the process maps of the members of the team; and c) assessing the team by providing a process map comprising the overlaid process maps of the members of the team. The terms “process map” and “overlaying” are elaborated below. The term “team” refers to a plurality of individuals (i.e., “members” or “constituents”) with common goals (i.e., “missions”) and tasks by which the goals are achieved. A team depends on the success of the individual constituents thereof. In certain embodiments, the team further includes a manager (e.g., coach or representative of the entity employing the team member(s).) A team can include as few as two members. In certain embodiments, a team of two members includes an individual and a coach.

In preferred embodiments, the method further includes constructing a process map of a virtual member of the team (i.e., “virtual team member”) wherein the method comprises the following steps: d) identifying deficiencies or excesses in each characteristic category of the team assessment; and e) constructing a process map of the virtual member of the team by ascribing to each characteristic category of the process map of the virtual member of the team a value which compensates for the deficiencies or excesses of the overlaid process maps of the members of the team. The terms “deficiency” and “excess” in the context of team assessment refer to a difference in the numeric value score of a particular characteristic category with respect to the corresponding value of an ideal team member. The term “ideal team member” refers to a hypothetical team member having numeric value scores associated with each characteristic category that compensate for the deficiencies and excesses of the corresponding characteristic categories of the assessment of the team. For example, an ideal team member does not necessarily dominate in all or even any characteristic category of the team process map. For example, a “deficiency” in a team member could refer to a predominate phase if that dominance distracts from the overall performance of the team. An ideal process map (i.e., the process map of a hypothetical team member with the optimal energy levels at each phase of the team process) can be constructed in view of the team assessment described above, which process map complements deficiencies or excesses identified by the team assessment. Accordingly, the terms “virtual member of the team” and “virtual team member” refer to a hypothetical team member having an ideal process map. In other embodiments, the virtual team member has a process map which fulfills a specific role or relationship within the team.

In other embodiments, the method further includes a method for identifying candidate team members comprising the following steps: f) comparing the process map of a virtual team member with a plurality of stored assessment data obtained for candidate team members; g) identifying a match between the virtual team member process map and the stored assessment data; and h) identifying the candidate team members associated with the stored assessment data. The term “candidate team member” refers to an individual or even another team which may be joined with the team for which the team assessment was conducted. The term “stored assessment data” refers to entries in a database comprising assessments. The method of comparison of step f) may be conducted in a variety of manners known to those of skill in the art. For example, the absolute values of the numerical difference between the numeric value scores of the ideal process map and the process maps of candidate team members can be summed to provide a composite comparison. In other embodiments, the differences are squared prior to summation. The term “identifying a match” refers to the identification within the stored assessment data of a process map of a candidate team member, or a set of candidate team members, which is similar or identical to the process map of the virtual team member. The term “identifying the candidate team member” refers to the database management step of providing the identification of the candidate team member by methods well known in the art.

In another aspect, the invention provides a system for conducting an assessment of a subject, which system comprises a server adapted to present to a subject at least one stimulus and to receive a response by the subject to each stimulus presented, wherein the at least one stimulus is selected in real time and corresponds to a characteristic category; and wherein the server is further adapted to determine an assessment of the subject based on the responses. In other embodiments, the server is further adapted to determine whether the assessment requires refinement between two or more characteristic categories, wherein the server is further adapted to present, when refinement is required, an additional stimulus corresponding to each of two or more characteristic categories.

In a further aspect, the invention provides a method for improving the performance (i.e., “coaching”) of current or potential team members in the furtherance of the team mission. In this context, coaching is conducted by a “coach” who is an individual responsible for training individual clients. The term “client” refers to an individual receiving coaching. In preferred embodiments, the method provides for the following steps: a) evaluating a client current process map to provide a client evaluation; and b) reciting the client evaluation to the client. The term “client current process map” refers to a process map of the client determined by methods of the invention, and which assessment is currently valid, i.e., represents the client now. A client current process map can be obtained contemporaneously with the coaching, or can be the result of a previous assessment of the client. The previous assessment of the client can have occurred, for example without limitation, 1-day, 1-week, 1-month, 2-months, 3-months, 6-months, or even longer, prior to the coaching. The term “client evaluation” refers to the level of energy the client has, or can bring to bear, to the phases of a success/satisfaction cycle as elaborated below, and can include a narrative description of the client in view of the client current process map.

In other embodiments, the invention further includes comparing the client current process map and a coach process map in order to provide a coach/client evaluation to determine for example how the client and coach would naturally prefer to work together. The term “coach process map” refers to a process map, as provided by the invention, resulting from an assessment of the coach. The term “coach/client evaluation” refers to the differences in the level of energy between the client and coach in the phases of a success/satisfaction cycle as elaborated below, and can include a narrative description of the client and coach comprising the strengths and weaknesses thereof, as measured by differences in the energy levels within the categories of the client current and coach process maps. Additionally, the coach/client evaluation may contain a narrative description of changes in the behavior of the client and the coach to improve the coach/client relationship. Additionally, the coach/client evaluation may contain a learning report, described below, of the client and a teaching report, described below, for the coach. In other embodiments, the coach/client evaluation is recited to the client by the coach. In yet other embodiments, the method provides an explicit list of changes in behavior which the client and coach can make to improve their ongoing working relationship.

In other embodiments, the method further includes reciting to the client the learning report of the client and the teaching report of the coach. The term “learning report of the client” refers to a written narrative describing the learning style of the client which is the manner in which the client would most naturally prefer to learn, as determined in view of the client current process map. Additionally, the learning report of the client can include a written description of changes in the behavior of the client to achieve more efficient task completion. The suggested changes in the behavior of the client are written from the perspective of the coach; i.e., the suggestions provide the coach with specific tasks and goals to give the client. The term “teaching report of the coach” refers to a written narrative describing the teaching style of the coach which is the manner in which the coach would most naturally prefer to teach (i.e., coach,) as determined in view of the coach process map. Additionally, the teaching report of the coach can include a written description of changes in the behavior of the coach to achieve more efficient task completion by the client. In other embodiments, the method further includes reciting to the client changes in the learning style of the client or changes in the teaching style of the coach to achieve more efficient task completion by the client. For example without limitation, if the client current process map indicated a predominant level in the analyze phase, the coach might advise the client to reduce the level of analysis activity in order to devote more focused energy, as defined below, to other phases.

In other embodiments, the method further includes comparing the client current process map and a client aspiration map to provide an ideal client evaluation. The term “client aspiration map” refers to a process map describing what dynamic strengths (i.e., energy levels within the phases of a success/satisfaction cycle) a client ideally desires. The client aspiration map can be created by the methods of the invention for assessment, further including an inquiry directed to the client's desires. Accordingly, the subject may be asked to respond to the stimuli to indicate a preference or a selection. In some embodiments, the requested response may be either “yes” or “no” to a query such as “DOES THIS OBJECT DESCRIBE WHAT YOU WOULD IDEALLY LIKE TO BE?” In other embodiments, the requested response may be a number between two extremes, for example, 1-2, 1-3, 1-5, 1-10, 1-100. For example, the query may be “ON A SCALE OF 1 TO 10, WHAT IS THE LEVEL AT WHICH THIS OBJECT DESCRIBES WHAT YOU WOULD IDEALLY LIKE TO BE?” In still other embodiments, the query may ask the subject to select an option from a plurality of options. For example, the query may be “PLEASE SELECT ONE OF THE FOLLOWING TO INDICATE HOW WELL THIS OBJECT DESCRIBES WHAT YOU WOULD IDEALLY LIKE TO BE,” and the subject may be presented with two or more options, for example: “STRONGLY AGREE,” “AGREE,” “NEUTRAL,” “DISAGREE,” and “STRONGLY DISAGREE.” The term “OBJECT” in this context refers to a presented stimulus. The term “ideal client evaluation” refers to the level of energy the client desires to bring to bear to the phases of a success/satisfaction cycle as elaborated below, and can include a narrative description of the client in view of the client aspiration map.

In other embodiments, the ideal client evaluation is recited to the client by the coach. In yet other embodiments, the method further includes reciting to the client changes in the behavior of the client to minimize the difference between the client current process map and the client aspiration map.

In other embodiments, the method further includes comparing the client current process map and a colleague process map to provide a colleague/client evaluation to determine how the client and the colleague prefer to work as a team. The term “colleague process map” refers to a process map, as provided by the invention, resulting from an assessment of the colleague. The term “colleague/client evaluation” refers to the differences in the level of energy between the colleague and client in the phases of a success/satisfaction cycle as elaborated below, and can include a narrative description of the colleague and client including the strengths and weaknesses thereof, as measured by differences in the energy levels within the categories of the client current process map and colleague process map. In other embodiments, the colleague/client evaluation is recited to the client by the coach. In other embodiments, the coach recites to the client changes in the behavior of the client and the colleague to increase success and satisfaction in the fulfillment of a task by the client or colleague.

In other embodiments, the method further includes comparing the client current process map with a task/project process map in order to provide a task/client evaluation. The term “task/project” refers to a task undertaken by a client as part of a project assigned to the client. The term “task/project process map” refers to a process map of an idealized client, which idealized client would be ideally suited to the performance of a specified task as part of a specific project. For example, the requirements of a task/project for a sales manager could include preferred motivate and activate energy levels and lower energy levels (e.g., select energy levels) in the analyze and strategize categories. Such a combination of energy levels would allow the idealized client to perform the duties of sales manager without wasting time. The term “task/client evaluation” refers to the differences in the level of energy between the client and task/project in the phases of a success/satisfaction cycle as elaborated below, and can include a narrative description of the client and task/project comprising the strengths and weaknesses thereof, as measured by differences in the energy levels within the categories of the process maps.

In other embodiments, the task/project process map is constructed by arithmetically averaging the individual corresponding numerical components (i.e., numeric value scores) of the phases of process maps of a plurality of real individuals who well perform the task. In this context, the term “well perform” refers to successful accomplishment of the subject task by the idealized client or plurality of real individuals with respect to any of a plurality of criteria of importance to management, including, for example without limitation, minimized time expenditure, minimized resource expenditure, maximized profit, and other criteria important to management and well known in the art. In other embodiments, the invention provides a method for constructing a task/project process map wherein an individual well skilled in the subject task creates the task/project process map based on personal experience. In a specific example without limitation, the individual well skilled in the subject task may determine that a specific task requires high motivate and analyze energies, and lower activate and strategize energies. In other embodiments, the numeric value scores assigned to each phase of the task/project process map by the individual well skilled in the subject task is subject to a compensating correction (e.g., 1, 2, 3 or 4 points up or down) in order to compensate for bias of the individual well skilled in the subject task. In other embodiments, the compensation is provided at the discretion of the individual well skilled in the subject task. For example, an individual well skilled in the subject task may have a very high energy (i.e., predominant) in a particular phase, e.g., analytic. In this case, the analytic energy level of the idealized process map created by the individual well skilled in the subject task may require compensation downward (e.g., by 1, 2, 3, or 4 points) in order to compensate for the inherent energy level of the individual well skilled in the subject task. In other embodiments, a plurality of individuals well skilled in the subject task (i.e., “assay group”) each create an idealized process map, and the individual corresponding numerical components of the phases of the resulting process maps are arithmetically averaged to create the task/project process map. In other embodiments, management may decide to compensate the individual energy levels within the task/project process map constructed by the method by a compensation factor (e.g., 1, 2, 3, or 4 points up or down) depending on the statistics of the numerical values for each energy level supplied by the assay group. For example, if each member of the assay specified a high analytic energy level in the idealized process map, the resulting analytic energy level may not require compensation. In contrast, if the assay group provided a range of values for analytic energy in the idealized process map, as measured by a large variance or standard deviation, the corresponding analytic energy level in the task/project process map may require compensation downward.

In other embodiments, the method further includes reciting the task/client evaluation to the client by the coach. In other embodiments, the method further includes reciting to the client changes to the behavior of the client to minimize the difference in energy levels between the client current process map and the task/project process map.

In other embodiments, the method further includes reciting to the client the working preferences of the client. The term “working preferences of the client” refers to how the client most naturally prefers to get things done. The classes of information provided thereby may include, without limitation, the ideal work environment of the client, the interaction skills of the client, client's ability to take direction and stay orientated to the task at hand, client's leadership abilities, client's decision making and risk taking preferences, and client's persuasive and sales ability. In other embodiments, the coach and client, in view of the client's working preferences, set mutual expectations and goals, and predict and improve performance.

In other embodiments, the method further includes reciting to the client the learning preferences of the client. The term “learning preferences of the client” refers to how the client most naturally prefers to learn. The classes of information provided thereby may include, without limitation, the ideal learning environment of the client, and the interaction skills of the client with a manager, teacher, or coach provided training.

In other embodiments, the method further includes visualizing how the client prefers to spend time on any task or role. In yet other embodiments, this visualization is used by the coach and client to set mutual expectations, and predict and improve performance. And in still other embodiments, the method further includes visualization of how the client prefers to spend focused energy on a task. The term “focused energy” is elaborated below. In yet other embodiments, this visualization is used by the coach and client to set mutual expectations, and predict and improve performance.

In other embodiments, the method further includes incorporating the client evaluation and the coach/client evaluation within an archive database. The term “archive database” refers to a computer data structure adapted to hold subject information (e.g., name, address, job position, and the like,) task information, assessments, process maps, evaluations, editing feedback, annotated responses, and comments by tie client and coach. Separate entries in the database, i.e., client archive and coach archive, are maintained for client and coach, respectively. The client archive is adapted so that the client cannot change an entry without permission of the coach or the employer of the client (i.e., management.) The archive database is configured and maintained by methods well known in the art.

In other embodiments, the method further includes annotating responses of the coach and the client within an archive database. The term “annotating” refers to providing written text for inclusion in the archive database to accompany a response.

In other embodiments, the method further includes receiving editing feedback by the client prior to entry of such feedback into the archive database. The term “editing feedback by the client” refers to editing entries provided by the client. The editing entries may include comments by the client which are incorporated into the client evaluation and stored in the archive database. The editing entries further may include a choice by the client regarding which elements of the client evaluation and client learning report that the client feels most correctly describe the client. The client may be presented with a plurality of elements of a client evaluation and given the opportunity to classify (i.e., mark) each element with a designation, for example without limitation, a) very much like me most of the time, b) somewhat like me some of the time, and c) not like me at all. Client evaluation elements marked as “a)” or b)” are retained in the client evaluation, and the client evaluation is re-written and stored in the client archive. All of the elements, irrespective of how marked by the client, are retained in the coach archive. Alternatively, the designations a), b) and c) can be replaced by a color code, for example green, yellow, and red, respectively. Additionally, the client may be presented with a plurality of elements of a client learning report and given the opportunity to classify each element with the following designations: a) very much like me most of the time, b) somewhat like me some of the time, and c) not like me at all. Then, client learning report elements marked as “a)” are retained in the client evaluation, and the client evaluation is re-written and stored in the client archive. All of the elements of the learning report, irrespective of how marked by the client, are retained in the coach archive. The designations a), b) and c) can be replaced by a color code, for example green, yellow, and red, respectively.

In further embodiments, the method further includes reviewing the archive database by the coach and the client in order to identify success and failure in a coach-client relationship. The term “success and failure in a coach-client relationship” refers to how well the coach and client work together (i.e., whether stress or anxiety are present in either coach or client,) how well the client responds to the teaching style of the coach (e.g., as measured by changes in the behavior of the client,) how well the coach responds to interaction with the client (e.g., as measured by changes in the teaching style of the coach in response to the client,) and how well the client ultimately performs the task forming the basis of the coaching.

In other embodiments, the method further includes repeating steps a) and b) and comparing the client evaluation so obtained with a client evaluation within the archive database to provide an updated client evaluation. The term “updated client evaluation” refers to a description of changes in the client evaluation. An updated client evaluation is useful for comparing possible changes in the client current process map over time, or to determine how a client performs in a different task at a later time, for example.

In another aspect, the invention provides a program product comprising machine readable program code for causing a machine to evaluate a client current process map to provide a client evaluation. In other embodiments, the program product further includes machine readable program code for causing a machine to compare the client current process map and a coach process map to provide a coach/client evaluation. In other embodiments, the program product further includes machine readable program code for causing a machine to compare the client current process map and a client aspiration map to provide an ideal client evaluation. In other embodiments, the program product further includes machine readable program code for causing a machine to compare a client current process map and a colleague process map to provide a colleague/client evaluation. In other embodiments, the program product further includes machine readable program code for causing a machine to compare a client current process map and a task/project process map to provide a task/client evaluation.

In another aspect of the invention, a system for conducting an assessment of a subject comprises a server adapted to present to a subject at least one stimulus and to receive a response by said subject to each said stimulus presented. The at least one stimulus is selected in real time and corresponds to a characteristic category. The server is further adapted to determine an assessment of said subject based on said responses. The assessment is determined based at least partly on elapsed time for said responses.

In one embodiment, the assessment is determined based on comparison of elapsed time for each response to a mean elapsed time for all responses from the subject.

In another embodiment, the server is adapted to assign a value to each response based on the elapsed time for that response. The value may be determined by applying a multiplier to a base value, the multiplier being dependent on the elapsed time. The server may be adapted to perform a statistical analysis on the values of the responses to determine the assessment.

In another embodiment, the server is adapted to perform a statistical analysis on the elapsed times of the responses to determine the assessment.

In one embodiment, the system further comprises a database of narratives corresponding to one or more assessments. The server is adapted to output a narrative from the database corresponding to the assessment determined.

In another aspect, the invention includes a method of conducting an assessment of a subject. The method comprises: a) presenting to a subject a first set of two or more stimuli, wherein at least two of said stimuli correspond to different characteristic categories; b) receiving a selection by said subject of one of said stimuli corresponding to a first characteristic category; c)repeating steps a) and b) as necessary with additional sets of stimuli; and d) outputting an assessment of the subject based on said responses. The assessment is determined based at least partly on elapsed time for said responses.

In another aspect, a program product comprises machine readable program code for causing a machine to perform the following method steps: a) presenting to a subject a first set of two or more stimuli, wherein at least two of said stimuli correspond to different characteristic categories; b) receiving a selection by said subject of one of said stimuli corresponding to a first characteristic category; c) repeating steps a) and b) as necessary with additional sets of stimuli; and d) outputting an assessment of the subject based on said responses. The assessment is determined based at least partly on elapsed time for said responses.

In another aspect of the invention, a system for conducting a relationship assessment of two or more subjects comprises a server adapted to present to each subject at least one stimulus and to receive a response by each subject to each stimulus presented, wherein the at least one stimulus is selected in real time and corresponds to a characteristic category. The server is further adapted to determine a characteristic category assessment of each subject based on the responses for one or more characteristic categories. The system further comprises a database of dyads, each dyad based on a characteristic category assessment of each subject and corresponding to a relationship assessment of a relationship between the subjects.

In one embodiment, the database of dyads includes narratives corresponding to one or more relationship assessments. The server is adapted to output a narrative from the database corresponding to the relationship assessment.

In another embodiment, each dyad includes a characteristic category assessment for at least one of the following characteristic categories: strategize, motivate, analyze and activate.

In another aspect of the invention, a method of conducting a relationship assessment of two or more subjects comprises: a) presenting to a subject a first set of two or more stimuli, wherein at least two of said stimuli correspond to different characteristic categories; b) receiving a selection by said subject of one of said stimuli corresponding to a first characteristic category; c) repeating steps a) and b) as necessary with additional sets of stimuli; d) determining a characteristic category assessment of the subject based on said responses for one or more characteristic categories; e) repeating steps a)-d) for each remaining subject; and f) outputting a relationship assessment of a relationship between the subjects based on the characteristic category assessments determined for each subject.

In another aspect of the invention, a program product comprises machine readable program code for causing a machine to perform the following method steps: a) presenting to a subject a first set of two or more stimuli, wherein at least two of said stimuli correspond to different characteristic categories; b) receiving a selection by said subject of one of said stimuli corresponding to a first characteristic category; c) repeating steps a) and b) as necessary with additional sets of stimuli; d) determining a characteristic category assessment of the subject based on said responses for one or more characteristic categories; e) repeating steps a)-d) for each remaining subject; and f) outputting a relationship assessment of a relationship between the subjects based on the characteristic category assessments determined for each subject.

### BRIEF DESCRIPTION OF THE FIGURES

FIG. 1 is a diagrammatic representation of a conventional Gestalt cycle of experience.

FIG. 2 is a diagrammatic representation of a success/satisfaction cycle derived from the Gestalt cycle of experience.

FIG. 3 is a table of exemplary word-pairs in four phases of the success/satisfaction cycle.

FIG. 4 is a flow chart illustrating a method for assessing a subject according to an embodiment of the invention.

FIGS. 5A, 5B, and 5C are screen shots illustrating an exemplary assessment process.

FIG. 6 is a table of exemplary word-pairs in four categories for use as stimuli in an assessment.

FIG. 7 is a flow chart illustrating a method for assessing a subject according to an embodiment of the invention.

FIG. 8 is a flow chart illustrating one embodiment of a method for refinement between categories.

FIG. 9 is a flow chart illustrating another embodiment of a method for refinement between categories.

FIG. 10 is a schematic illustration of a front end of a system according to an embodiment of the invention.

FIG. 11 is a schematic illustration of a back end of a system according to an embodiment of the invention.

FIG. 12 illustrates an exemplary dyad database according to embodiments of the present invention.

### DETAILED DESCRIPTION OF THE PREFERRED EMBODIMENTS

The present invention provides assessment systems, methods and program products that are based on a combination of the Method of Paired Comparisons and Task Completion from a Gestalt framework. Forced choice comparisons may be administered to a user either physically or electronically through software, for example, Flash, PHP, and other interactive software designed by products well known in the art. The assessments may be applied to individuals, groups of individuals, or to idealized individuals or teams to create a template for subsequent screening of individuals.

The Method of Paired Comparisons is based on Thurstone's Law of Comparative Judgment. When a person is presented with a stimulus, such as a word-pair or a picture, a sequence of events occurs. The distal stimuli are patterned on the retina, then transferred into electrical signals and delivered to the brain. The brain then sets up mental representations bio-chemically using separate groups of neurons, one group for each stimulus. These events are massively parallel and can involve tens of thousands of neurons along with the electrochemical interactions between them.

In the case of the assessment of embodiments of the present invention, when an individual is presented with stimuli such as word-pairs for comparison, a neurological mechanism triggers two mental representations—one for each of the stimuli. The representation that the individual most prefers will create the highest neurological signal strength, causing that pair to be selected.

Although an individual believes that they are consciously “choosing” one of the word-pairs, in reality, it is the electrochemical process within the brain that applies certain rules and controls the response.

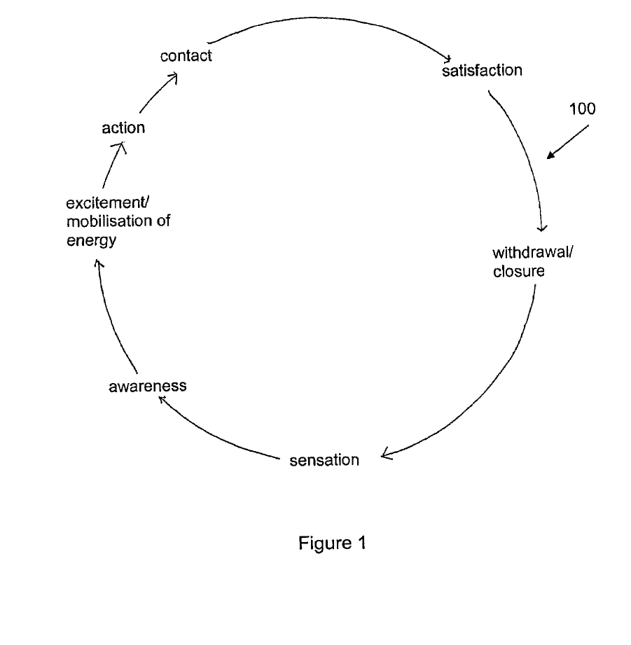

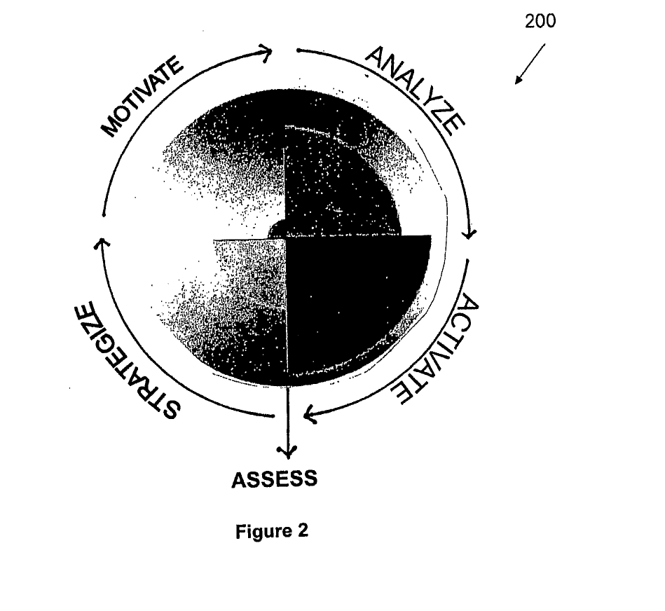

In certain embodiments of the invention, the stimuli are word-pairs to be selected by the subject. The words used in the word-pairs are derived from descriptive words attributed to specific phases found in the success/satisfaction cycle derived from the Gestalt Framework and in the descriptors of significant brain processes. The term “success/satisfaction cycle” refers to a process by which a subject completes or processes a task, for example. The success/satisfaction cycle may include a plurality of phases through which a task is processed by the subject. The processing may be in sequential order or may be in parallel. The success/satisfaction cycle had its origin in the systematic approach to the development and application of the Gestalt Figure-Ground model as it relates to the organization of individual and group experiences. Edwin C. Nevis' book entitled Organizational Consulting: A Gestalt Approach (Gardner Press, Incorporated; (Dec. 1, 1987)) was the model and foundation for which the success/satisfaction cycle was derived from the Gestalt Cycle of Experience. FIG. 1 diagrammatically illustrates the Gestalt Cycle of Experience 100, and FIG. 2 illustrates success/satisfaction cycle 200.

In illustrated embodiments of the present invention, the success/satisfaction cycle assesses a subject's experience through five phases of the success/satisfaction cycle: strategize, motivate, analyze, activate, and assess. Accordingly, the term “phase” refers to a discrete component of the success/satisfaction cycle, as illustrated for example in FIG. 2. Similarly, the term “phase in a success/satisfaction cycle” refers to a discrete component of the success/satisfaction cycle, as illustrated for example in FIG. 2. In certain embodiments, the term “dynamic” is used synonymously with the term “phase” in referring to the success/satisfaction cycle. In certain embodiments, the cycle is envisaged as a linear sequence of dynamics in the order explore, excite, examine, and execute, wherein the execute and explore dynamics are connected by the “evaluate” dynamic.

The names of the phases of the success/satisfaction cycle are alternatively named within the art. Such alternative names can describe a characteristic category of the phase. For example, without limitation, the strategize phase may also be known as the “synthesize” or “explore” phase or dynamic; the motivate phase may also be known as the “interactive” or “excite” phase or dynamic; the analyze phase may also be known as the “analytical,” “articulate,” or “examine” phase or dynamic; the activate phase may also be known as the “conclude” or “execute” phase or dynamic, and the assess phase may also be known as the “evaluate” phase or dynamic. Furthermore, the phases can be referred to by reference to one who performs the function of the phase. For example, without limitation, the strategize phase can be referenced by the terms “strategizer,” “synthesizer, “” articulator,” or “explorer;” the motivate phase can be referenced by the terms “motivator,” “interactor,” or “excitor;” the analyze phase can be referenced by the terms “analyzer” or “examiner;” and the activate phase can be referenced by the term “concluder.”

Each assess (e.g., evaluate) phase of the success/satisfaction cycle has two parts to it: success and satisfaction. The process of measurement within this phase is different for each individual or group and may be based on many factors (e.g., cultural, educational, timelines for completion, past experiences with this specific process, etc.). Some subjects may place more emphasis on the external process measurements of success and others on the internal measurement of satisfaction, for example.

Each phase has a characteristic level of energy, focus or time associated with it for each subject. In some embodiments, the characteristic level of energy is represented by a numeric value score. These levels vary from subject to subject, but are generally robust for the same subject. In certain embodiments, the levels of energy are divided into four categories in descending order and exemplarily named, without limitation, energy: predominant, preferred, select and stress/avoid. A phase categorized as “predominant” dominates the subject's process. Most time and energy is spent in this phase, while other phases of the cycle are given little credence or are ignored, and moving the subject to other phases of the cycle can be difficult and sometimes stressful for associates or colleagues. A phase that is categorized as “preferred” is used often, naturally and most comfortably. This phase operates at the lowest stress, both for the subject and for those around the subject. A phase categorized as “select” can be consciously engaged by the individual to adapt to a particular task or relationship. The subject can spend long periods of time in this phase of select intensity and not become stressed. Extended time spent in a phase categorized as “stress/avoid” can cause stress to the subject and usually is avoided by the subject when possible. This phase can be engaged for limited periods of time, but will lead to stress effects and exhaustion.

In will be understood by those of skill in the art that multiple terms describe the characteristic energy levels of the phases of the success/satisfaction cycle as described herein. As an example, without limitation, the term “extreme” may be used synonymously with “predominant,” “effortless” with “preferred,” “deliberate” with “select,” and “stress” with “stress/avoid.”

Associated with each characteristic energy level is a preference for the amount of time which a subject would naturally prefer to spend on a task or project. The term “focused energy” refers to the level of energy which a subject would naturally prefer to spend on a task or project. In this context, the extreme, effortless, deliberate, and stress energy levels may be associated, without limitation, with the terms “prolonged,” “appropriate,” “short,” and “too much/too little,” respectively.

The terms “process profile,” “process style,” and “process map,” all of which can be used interchangeably and without limitation, refer to the data forming an assessment, i.e., to the natural levels of energy, as described herein, which a subject can bring to bear on the accomplishment of a task. That is, a process map is a description of the energy, focus, or time which is associated in a subject with each phase of the Gestalt success/satisfaction cycle as illustrated in FIG. 2. Similarly, the term “ideal process profile,” “ideal process style,” and “ideal process map” refer to an idealized process profile as described herein.

As understood of those of skill in the art, individuals within a team fulfill different roles, which roles have characteristic names, for example, without limitation, “leader”, “member”, “facilitator”, “scribe”, “liaison”, and “energizer”. A team leader provides guidance for the team, performs administrative duties, and ensures that good team practices are followed, wherein “good” in this context refers to the eventual successful completion of tasks assigned to the team, and “practices” refers to the means by which specific goals are achieved. A team member works with other individuals within a team to accomplish the team mission while following good team practices. A team facilitator helps accomplish team goals as needed, is a teacher and builder of consensus within the team, is a problem solver and conflict-resolver, and is an expert in the means by which the team accomplishes its goal. The facilitator looks at the group, perceives problems, and identifies routes by which problems can be circumvented. The scribe records the minutes of team meetings, reconstructs the meeting in written form, submits the written minutes for review, and distributes the minutes. The liaison serves as the point of contact with other entities, for example, without limitation, other teams, management, and entities external to the organization of which the team is part. The energizer fulfills the role of liaison, and provides additional motivation and positive energy focus for the team and its members.

A diverse, high respect team, wherein “diverse” refers to the breadth of ability of the team taken as a whole, and “high respect” is a subjective designation assigned to the team by external entities including, without limitation, other teams, management, and entities external to the organization of which the subject team is a member, is well described by the overlay of the process maps of the individual constituents of the team. The assessments provided by the instant invention for individual team constituents are viewed as a process map, exemplified, for example, by FIG. 2. Accordingly, the overlay of the individual process maps (i.e., the “team process map”) of the constituents of the team represents the process map of the team taken as a whole, i.e., the “team assessment”. In full view of the individual process maps of the team constituents, roles (e.g., leader, facilitator, scribe, or liaison/energizer) for each team member can be recommended. Furthermore, gaps in the team process map become apparent to team members and supervision. The appreciation of such gaps guide the addition or subtraction of team members to optimize the constituents of the team, and hence, the effectiveness of the team as a whole.

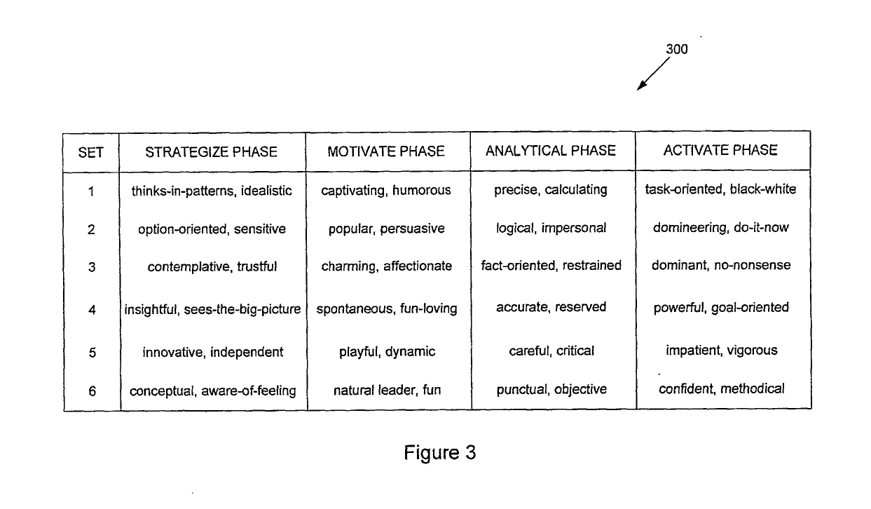

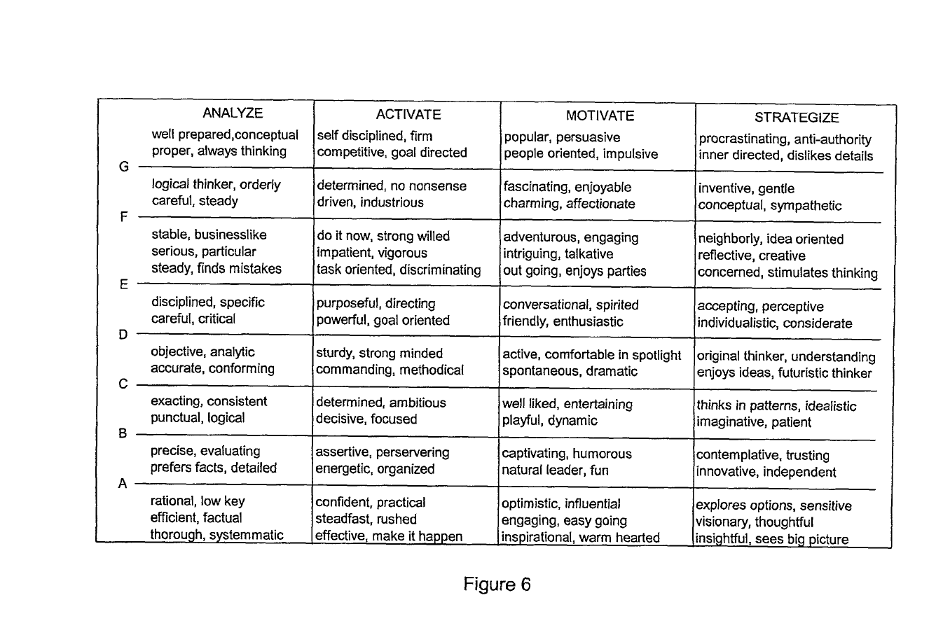

FIG. 3 illustrates a table 300 of exemplary sets of word-pairs for use with embodiments of the present invention. The table 300 comprises six sets of word-pairs, but additional sets may also be provided, for example FIG. 6. When a set is presented to the subject, the set may be selected according to a predetermined order or randomly from the available sets. In certain embodiments, each set includes a word-pair for each of the four phases in the success/satisfaction cycle. In other embodiments, additional categories or phases may be included and be provided with a word-pair for each set.

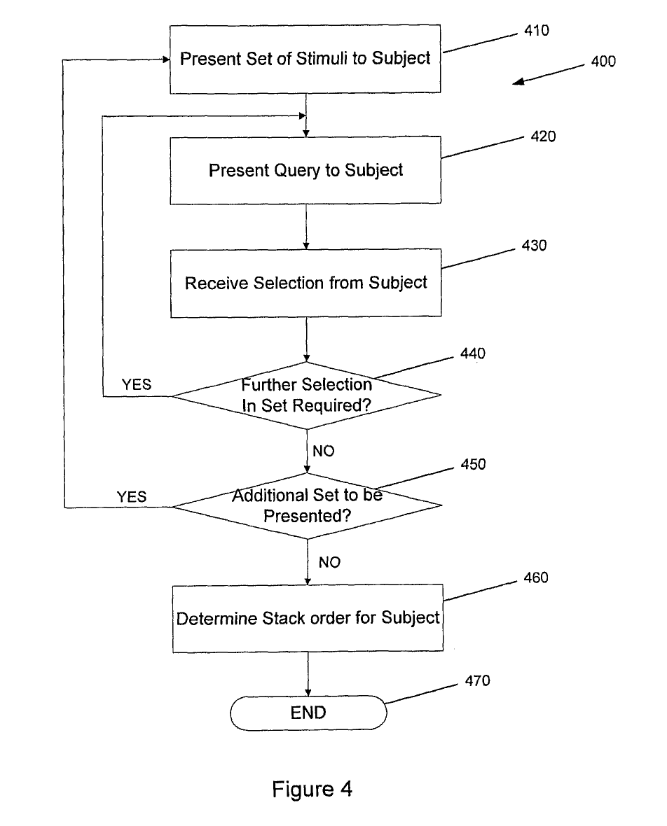

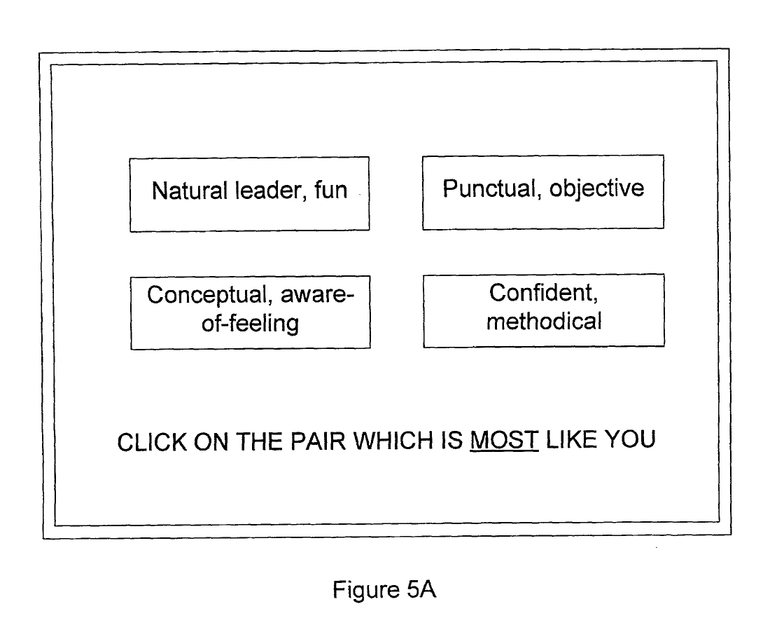

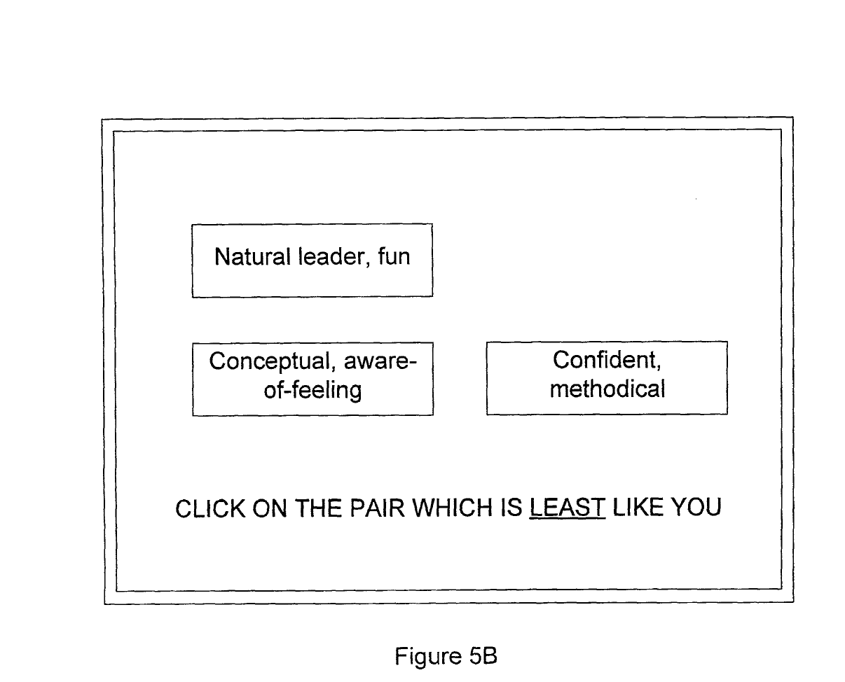

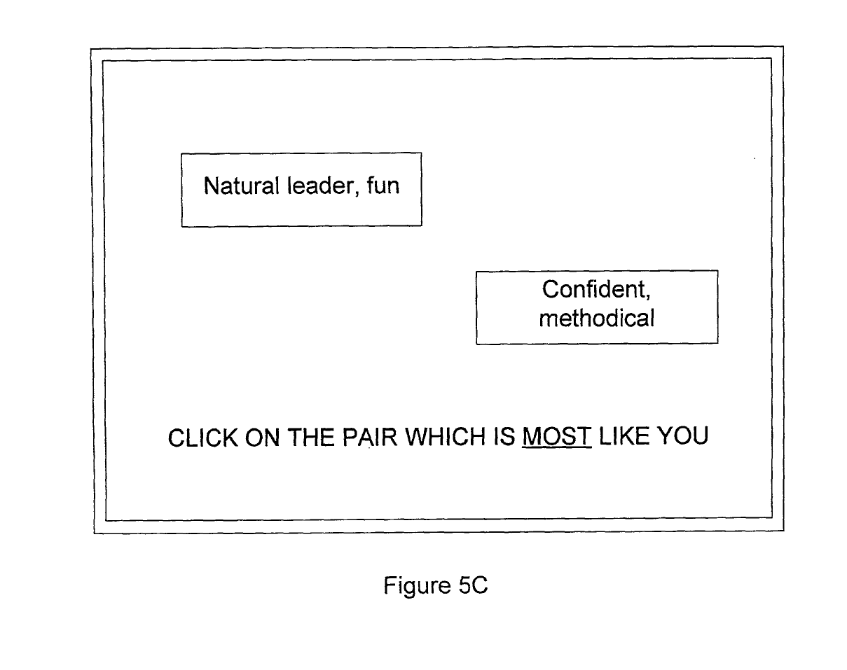

FIG. 4 is a flow chart illustrating an exemplary assessment method according to certain embodiments of the invention. The method 400 begins with the presentation of a set of stimuli to the subject (block 410). The presentation may be physical, electronic or verbal. The stimuli may include photographs, diagrams, sketches or other vehicles. In particular embodiments, the stimuli are word-pairs. The set of stimuli includes two or more stimuli for selection by the subject. In the exemplary embodiment described below with reference to FIGS. 3 and 5A, each set includes four word-pairs.

At block 420, a query is presented to the subject. Again, the presentation may be physical, electronic or verbal. Furthermore, the presentation of the query and the presentation of the set of stimuli may be simultaneous or reversed in order. The query is designed to elicit a selection by the subject of one stimulus from the set of stimuli (block 430).

At block 440, a determination is made as to whether additional selections are required from the subject from the set of stimuli. If the determination is made that additional selections are required, the method 400 returns to block 420. For example, in the exemplary embodiment with four word-pairs in the set of stimuli, after the subject selects one stimulus, additional selections may be required to determine a relative ordering of the remaining stimuli. On the other hand, if the determination is made that no additional selections are required, the method 400 continues to block 450. For example, in the exemplary embodiment with four word-pairs in the set of stimuli, after repeated selections, a single stimulus may remain unselected. Thus, no additional selection is required for ordering.

At block 450, a determination is made as to whether an additional set is to be presented to the subject. If the determination is made that an additional set is to be presented, the method 400 returns to block 410 and presents a new set of stimuli to the subject. In certain embodiments, additional confidence in the final stack order may be achieved by processing of multiple sets of stimuli. In one embodiment, the method 400 includes processing two sets of stimuli. In another embodiment, three or more sets of stimuli are processed for each subject.

If a determination is made at block 450 that no additional sets are to be presented, the method 400 proceeds to block 460, and a stack order is determined for the subject. A stack order is indicative of the assessment of the subject. The method 400 then terminates at block 470. In the exemplary embodiment described above, the stack order is indicative of the relative ordering of the various categories or phases of the success/satisfaction cycle. In the case of a single set of stimuli presented to the subject, the stack order may be a direct mapping of the word-pair selections. In the case of multiple sets of stimuli presented to the subject, a scoring method may be used to determine an overall stack order.

FIGS. 5A-5C are screen shots that may be presented to the subject on, for example, the user device 510 of FIG. 5 by the web server 520. FIG. 5A includes the initial presentation of a set of stimuli including four word-pairs, each corresponding to a category or phase of the success/satisfaction cycle. The illustrated set of stimuli corresponds to Set number 6 in the table 300 of FIG. 3. Along with the set of stimuli, a query asks the subject to select the word-pair which most accurately describes the subject. Upon selection by the subject of one of the word-pairs, the screen is updated to the screen shot illustrated in FIG. 5B. In this case, the user has selected the word-pair “Punctual, objective”, which corresponds to the analytical phase. Thus, the analytical phase is placed at the top of the stack order.

As illustrated in FIG. 5B, the subject is then presented with the remaining stimuli in the set, along with a query asking the subject to select, from the remaining stimuli, the word-pair which is least accurately describes the subject. Upon selection by the subject of one of the remaining word-pairs, the screen is updated to the screen shot illustrated in FIG. 5C. In this case, the user has selected the word-pair “Conceptual, aware-of-feeling”, which corresponds to the strategize phase. Thus, the strategize phase is placed at the bottom of the stack order.

Finally, the subject is presented with the remaining two word-pairs and a query to complete the stack order, as illustrated in FIG. 5C. The query asks the subject to select the word-pair which more accurately describes the subject. The phase corresponding to the word-pair selected by the subject is placed second on the stack order, with the category or phase corresponding to the non-selected word-pair being placed third.

The exemplary assessment illustrated in FIG. 5A-5C is achieved with a single set of stimuli and a mere three clicks or selections by the subject. Thus, an assessment can be obtained in a rapid manner. For additional confidence in the assessment, the process of FIGS. 5A-5C may be repeated with additional sets of stimuli, each set requiring only three additional clicks by the subject.

FIG. 6 illustrates another exemplary table of stimuli to be presented to a subject as part of an assessment.

In the illustrated embodiment, each stimulus is a word-pair corresponding to a characteristic category. The embodiment illustrated in FIG. 6 includes four characteristic categories. In other embodiments, more or fewer categories may be used. Each category refers to a characteristic, a phase or other feature of a subject or an assessment, and each characteristic category may correspond to a characteristic or feature associated with an emotional, physical, biological and/or intelligence characteristic, for example. In the illustrated embodiment, each characteristic category corresponds to a phase of the success/satisfaction cycle of FIG. 2.

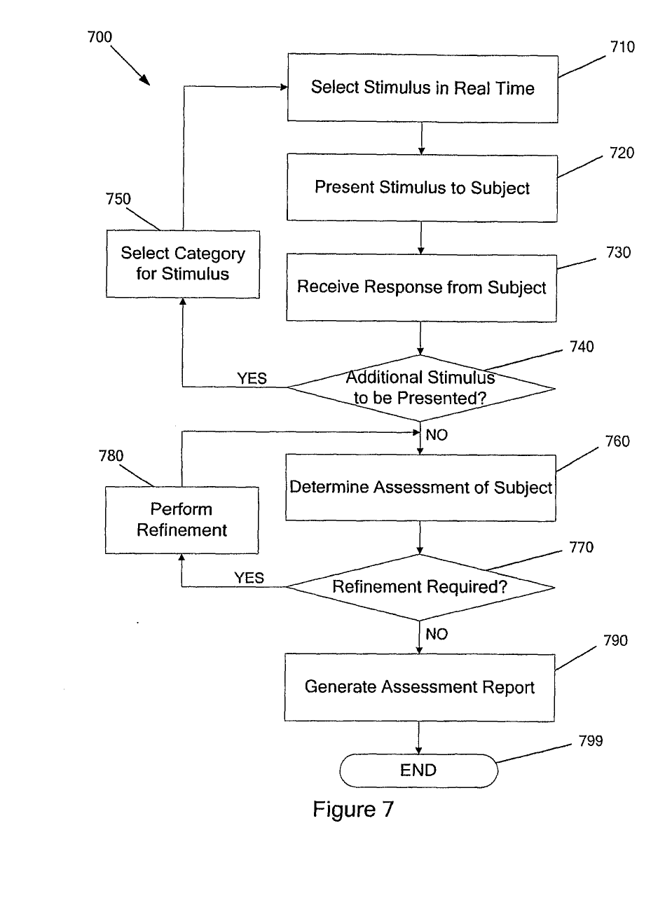

Referring to FIG. 7, a method of assessing a subject according to certain embodiments of the invention is illustrated. The method 700 begins with the selection of a stimulus in real time. The stimulus may be selected from a list, a table or a database, for example. The selection of the stimulus may be completely or partially random. For example, with reference to FIG. 6, a selection may be completely random by selecting any word-pair in any of the four categories, or may be partially random by selecting a word-pair from a selected category, such as the “SYNTHESIZER” category.

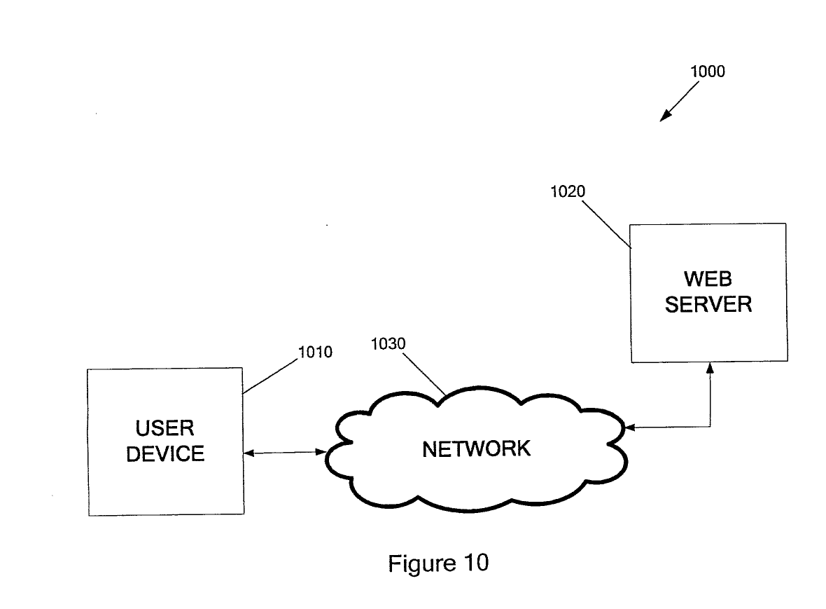

In other categories, the selection of the stimulus may be guided by information relating to the subject and/or the client with which the subject is associated. Such information may be obtained from the user database 1040 of FIG. 10. For example, the information obtained from the user database 1040 may indicate that the subject has already been assessed and may include the specific stimuli presented to the subject. Accordingly, the selection of the stimuli at block 710 of FIG. 7 may be guided to avoid the stimuli already presented to the present subject.

The stimulus may be any device, such as photos, images, graphics, sketches or the like, selected to elicit a response from the subject. In one embodiment, each stimulus is a word-pair, such as the word-pairs illustrated in FIG. 6.

The selection of the stimulus in real time is facilitated by implementing the assessment as a computer-based method.

Referring again to FIG. 7, at block 720 the selected stimulus is presented to the subject. In this regard, the stimulus may be presented by displaying the stimulus as graphics, text, audio, video, or the like. The display may include the use of a computer or other electronic device by the subject, such as a standalone or a networked computer. In certain embodiments, the communication resulting in display is conducted through a communication network, such as the Internet. In being presented the stimulus, the subject may be asked to respond to the stimulus to indicate a preference or a selection. The required response may be either a “yes” or a “no” to a query such as “DOES THIS WORD-PAIR DESCRIBE YOU?” In other embodiments, the response may be a number between two extremes, for example, 0-100, 0-10, 1-10, 1-5. For example, the query may be “ON A SCALE OF 1 TO 10, THE LEVEL AT WHICH THIS WORD-PAIR DESCRIBES YOU?” In still another embodiment, the query may ask the subject to select an option from a choice of options. For example, the query may be “PLEASE SELECT ONE OF THE FOLLOWING TO INDICATE HOW WELL THIS WORD-PAIR DESCRIBES YOU,” and the subject may be presented with the following options: “STRONGLY AGREE,” “AGREE,” “NEUTRAL,” “DISAGREE,” and “STRONGLY DISAGREE.”

At block 730, the response from the subject is received. In this regard, a signal or an input may be acquired from the subject.

At block 740, a determination is made as to whether an additional stimulus is to be presented to the subject. The assessment may require a minimum number of stimuli to be presented for each characteristic category, for example. In this regard, if a sufficient number of stimuli has not been presented, the method 700 returns to block 710 to select another stimulus to be presented. In certain embodiments, as illustrated by block 750, a characteristic category for the next stimulus may be selected to facilitate a complete assessment.

Alternatively, if the determination is made at block 740 that no more stimuli are required for the assessment, the method 700 proceeds to block 760, and an assessment of the subject is determined. In this regard, responses of the subject to the stimuli presented may be evaluated. In one embodiment, a scoring method may be used to determine an overall stack order for the subject. For example, each “STRONGLY AGREE” response may be assigned five points, an “AGREE” response assigned four points, etc. The numeric value score for each characteristic category may determine the position of that category in the stack order. A stack order is indicative of the assessment of the subject. In the exemplary embodiment described above, the stack order is indicative of the relative ordering of the various categories or phases of the success/satisfaction cycle.

At block 770, a determination may be made as to whether a refinement of the stack order is required with respect to two or more characteristic categories. For example, the assessment may require a minimum difference (i.e., refinement criterion) in the numeric value scores to distinguish between two categories and, if the numeric value scores of two categories differ by less than that required minimum, a refinement may be required to accurately determine their respective positions in the stack order.

In certain embodiments, the numeric value score for each characteristic category is calculated by assigning a weight to each stimulus (e.g., word-pair of FIG. 6,) accumulating the weights as the assessment is conducted, and finally presenting the accumulated weights as the numeric value score for each characteristic category. In some embodiments, equal weight (i.e., 1 point) is accorded to each stimulus. In other embodiments, variable weight is afforded each word-pair. In one embodiment, the word-pairs below line “A” of FIG. 6 are accorded a value greater than 1, e.g., 2, 3, 4, 5, 6, 7, 8, 9, or 10, while word-pairs above line “A” are accorded a lower value. In another embodiment, the word-pairs below line “B” of FIG. 6 are accorded a value greater than 1, e.g., 2, 3, 4, 5, 6, 7, 8, 9, or 10, while word-pairs above line “B” are accorded a lower value. In another embodiment, the word-pairs below line “C” of FIG. 6 are accorded a value greater than 1, e.g., 2, 3, 4, 5, 6, 7, 8, 9, or 10, while word-pairs above line “C” are accorded a lower value. In another embodiment, the word-pairs below line “D” of FIG. 6 are accorded a value greater than 1, e.g., 2, 3, 4, 5, 6, 7, 8, 9, or 10, while word-pairs above line “D” are accorded a lower value. In another embodiment, the word-pairs below line “E” of FIG. 6 are accorded a value greater than 1, e.g., 2, 3, 4, 5, 6, 7, 8, 9, or 10, while word-pairs above line “E” are accorded a lower value. In another embodiment, the word-pairs below line “F” of FIG. 6 are accorded a value greater than 1, e.g., 2, 3, 4, 5, 6, 7, 8, 9, or 10, while word-pairs above line “F” are accorded a lower value. In another embodiment, the word-pairs below line “G” of FIG. 6 are accorded a value greater than 1, e.g., 2, 3, 4, 5, 6, 7, 8, 9, or 10, while word-pairs above line “G” are accorded a lower value.

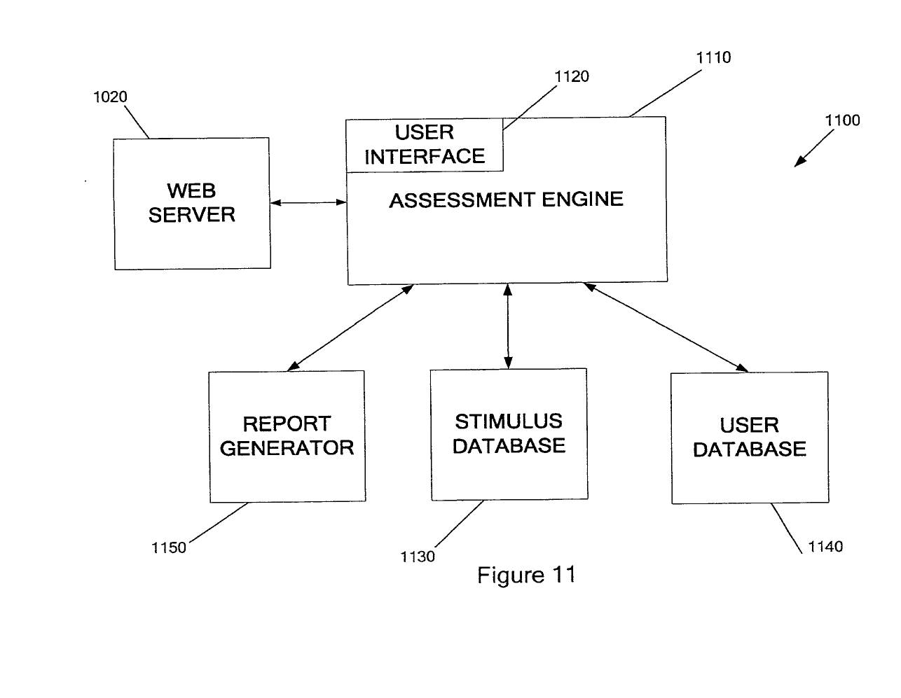

If the determination is made at block 770 that no refinement is required, the process 700 proceeds to block 790 to generate an assessment report. With reference to FIG. 11, the report may be generated by a report generator 1150 based on the responses to the stimuli and the determination of the assessment for the subject in block 760 of FIG. 7. The method 700 then terminates at block 799.

On the other hand, if the determination is made at block 770 that a refinement is required, the process 700 proceeds to block 780 to perform a refinement. Once the refinement is completed, the method 700 returns to block 760 to again determine the assessment of the subject.

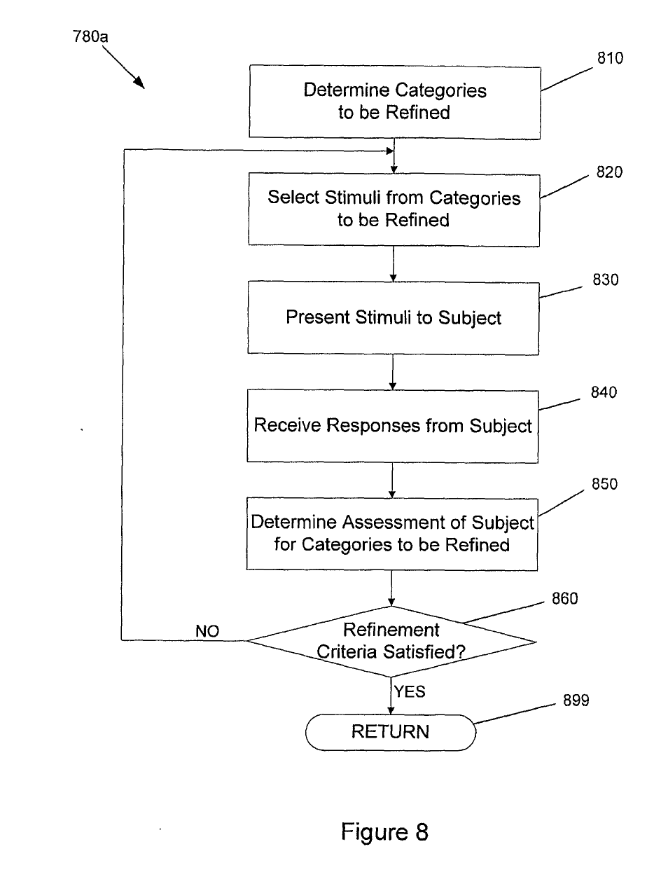

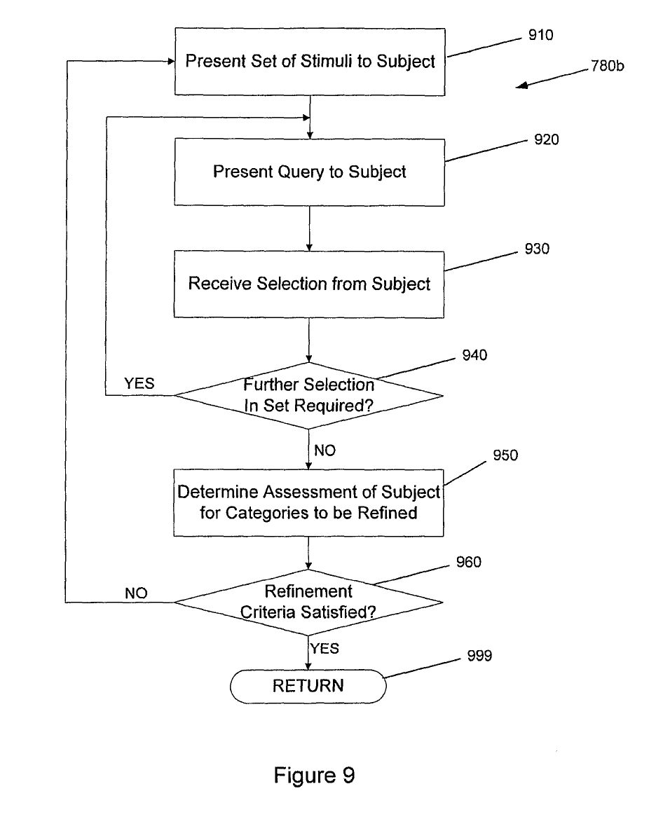

The refinement required by the determination at block 770 may be performed in a variety of manners. Two refinement methods according to embodiments of the invention are illustrated in FIGS. 8 and 9, described below.

One embodiment of the refinement method 780a illustrated in FIG. 8 begins with the determination of the categories to be refined at block 810. In this regard, the categories may be received from the assessment determined at block 760 of FIG. 7, for example. Refinement may be required between any number of the categories, including two categories, three categories or four categories in the above-illustrated example with four characteristic categories of the assessment.

At block 820, stimuli are selected from the categories to be refined. In this regard, the stimuli may be selected, for example, from the table of stimuli illustrated in FIG. 6 or from another database. In blocks 830 and 840, the stimuli are presented to the subject, and responses are received. Blocks 820, 830 and 840 are illustrated in FIG. 8 as being performed in batch form (i.e., all stimuli are first selected, then presented and all responses received). However, it is also contemplated that the functions of these blocks may be performed for one stimulus at a time, and the blocks repeated for each stimulus.

At block 850, an assessment of the subject is determined for the categories to be refined as a sub-assessment. In this regard, the assessment may be determined using the same or a different scoring method as the determination of an assessment at block 760 of FIG. 7.

Referring again to FIG. 8, at block 860, a determination is made as to whether a refinement criterion has been satisfied. The refinement criterion may require a certain differential (i.e., required minimum) in the numeric value scores for the categories to be refined, for example, similar to the minimum differential required at block 770 of FIG. 7. The differential may be a fixed value of may be a function of the number of stimuli presented in the refinement method 780a, for example.

If the determination is made at block 860 that the refinement criterion is not satisfied, the method 780a returns to block 820, and additional stimuli are selected from the categories to be refined. This process may be repeated as often as necessary to satisfy the refinement criterion. It is noted that with increasing number of stimuli presented, the accuracy of the assessment increases.

On the other hand, if the determination is made at block 860 that the refinement criterion has been satisfied, the method 780a proceeds to block 899, and the results of the refinement are returned to the method 700 of FIG. 7.

FIG. 9 is a flow chart illustrating another exemplary refinement method according to an embodiment of the invention. The method 780b begins with the electronic presentation of a set of stimuli to the subject (block 910). The stimuli may include photographs, diagrams, sketches or other vehicles. In particular embodiments, the stimuli are word-pairs. The set of stimuli includes two or more stimuli for selection by the subject. In the exemplary embodiment described below with reference to FIGS. 3 and 5A, each set includes four word-pairs.

At block 920, a query is presented to the subject. The presentation of the query and the presentation of the set of stimuli may be simultaneous or reversed in order. The query is designed to elicit a selection by the subject of one stimulus from the set of stimuli (block 930).

At block 940, a determination is made as to whether additional selections are required from the subject from the set of stimuli. If the determination is made that additional selections are required, the method 780b returns to block 920. For example, in the exemplary embodiment with four word-pairs in the set of stimuli, after the subject selects one stimulus, additional selections may be required to determine a relative ordering of the remaining stimuli. On the other hand, if the determination is made that no additional selections are required, the method 780b continues to block 950. For example, in the exemplary embodiment with four word-pairs in the set of stimuli, after repeated selections, a single stimulus may remain unselected. Thus, no additional selection is required for ordering.

At block 950, the assessment of the subject for the categories to be refined is determined. The determination of the assessment may include determining a stack order for the subject. A stack order is indicative of the assessment of the subject. In the exemplary embodiment described above, the stack order is indicative of the relative ordering of the various categories or phases of the success/satisfaction cycle. In the case of a single set of stimuli presented to the subject, the stack order may be a direct mapping of the word-pair selections. Thus, if a refinement was required between “INTERACTOR” and “CONCLUDER” categories, the relative placement of those categories in the stack order may be used as the assessment of the subject for those categories.

At block 960, a determination is made as to whether a refinement criterion has been satisfied. The refinement criterion may require a certain relative placement of the categories to be refined in the stack order or a reproducibility of a relative placement in consecutive stack orders, for example. In one embodiment, the refinement criterion may require that the categories to be refined be in the same relative placement in two consecutive stack orders. For example, if a refinement was required between “INTERACTOR” and “CONCLUDER” categories, the refinement criterion may be satisfied if the “INTERACTOR” category places higher than the “CONCLUDER” category in three consecutive stack orders.

If the determination is made at block 960 that the refinement criterion has not been satisfied, the method 780b returns to block 910, and an additional set of stimuli is presented. On the other hand, if the refinement criterion is determined to have been satisfied at block 960, method 780b proceeds to block 999 and returns to block 760 of FIG. 7.

In certain embodiments, the set of stimuli of the invention maybe presented to a subject on a remote computer by a web server. One such system is illustrated in FIG. 10. The system 1000 includes a user device 1010 adapted to communicate with a web server 1020 through a communication network 1030. The user device may be any of a variety of devices, such as a desktop or a laptop computer. In other embodiments, the user device 1010 may be a portable or wireless device such as a wireless phone, a personal digital assistant (PDA) or other handheld device.

The web server 1020 may be any computing device provided with server software, for example. Thus, the user device 1010 and the web server 1020 may communicate via a server-client relationship. The web server 1020 may be provided with software adapted to present the user device 1010 with the stimuli and the queries for display on a monitor connected to or part of the user device 1010.

The communication between the user device 1010 and the web server 1020 may be facilitated via a direct link. In the illustrated embodiment, the user device 1010 and the web server 1020 communicate through a communication network 1030. The communication network 1030 may be private or public. In one embodiment, the communication network 1030 is the public switched telephone network (PSTN). In another embodiment, the communication network 1030 is a network of computers, such as the Internet. In one embodiment, the communication between the user device 1010 and the web server 1020 is encrypted by means well known in the art, for example, secure hypertext transfer protocol.

Thus, FIG. 10 provides a front-end system 1000 for allowing a subject to access the assessment software through the web server 1020. FIG. 11 illustrates a complementary back-end system 1100 for conducting the assessment of the subject. The back-end system 1100 includes an assessment engine 1110 for controlling the administration of the assessment. The assessment engine 1110 includes the software for administration and evaluation of the assessment. Components of the software are exemplarily illustrated in FIGS. 7-9 and are described herein in greater detail.

The back-end system 1100 includes a user interface 1120 for providing an interface through which the subject can interact with the assessment engine 1110. The user interface 1120 may be adapted to present the subject with a graphical user interface on the user device 1100 of FIG. 10. The user interface 1120 may be adapted to provide graphics, text, data, audio or video data to the subject and may be adapted to receive input from the user through one or more input devices, such as a keyboard, mouse, microphone or camera, for example.

FIG. 11 illustrates a two-way communication link between the web server 1020 and the assessment engine 1110. Such communication link may be direct, indirect or through a network. The back-end system 1100 includes a stimulus database 1130 for storing stimuli to be presented to the subject. The stimulus database 1130 may include stimuli in the form of a table, list or a database. Further, the stimulus database 1130 may be adapted to be updated or modified through an administrator input, for example. Such updates or modifications may be necessary to include additional stimuli or to delete existing stimuli.

A user database 1140 is provided to store information relating to subjects or clients. In this regard, the subjects may include individuals, groups of individuals or entities. Similarly, clients may include individuals, groups of individuals or entities, such as a company. Each client may be associated with one or more subjects. The database may include information relating to subjects or clients that have been assessed or have registered for an assessment, for example.

The back-end system 1100 may also include a report generator 1150. The report generator 1150 is adapted to receive the assessment results or the raw responses from the subject and to generate an assessment report tailored for the subject and/or the client, for example. The report may include text, graphics or other forms of information related to the assessment. In one embodiment, subject material provided by the report generator is identified by comparing the assessment results from the subject to a library of subject material referenced by characteristic energy levels of the phases of the success/satisfaction cycle.

It will be understood by those skilled in the art that the various modules illustrated in FIG. 11, including the assessment engine 1110, the user interface 1120, and the report generator 1150 may be implemented in a single software module or may be further separated into additional sub-modules. Further the various modules may be implemented as software, hardware or firmware. Further, the stimulus database 1130 and the user database 1140 may be implemented as lists, tables or databases, for example, and may be stored on various memory devices well known in the art.

In another aspect of the invention, the assessment of a subject may incorporate the time it takes for the subject to respond to a stimulus. In this regard, the system (e.g., server administrating the assessment) may measure the elapsed time between the presentation of the stimulus and receipt of a response from the subject. The elapsed time may be of interest as it may reflect the accuracy of the response. For example, a short elapsed time may indicate the subject was very confident of the response, while a longer elapsed time may indicate a lower level of confidence.

The elapsed time may be incorporated into the assessment in numerous ways. For example, in one embodiment, once the subject has completed responding to all assessment stimuli, the elapsed time for each response may be compared to the mean elapsed time for all responses by the subject. In this manner, the elapsed time factor is normalized to account for any issues related to the ability of the subject to respond to stimuli quicker or slower.

In another embodiment, a value may be assigned to each response, and the value may be influenced by the elapsed time for that response. For example, the value may be determined by applying a multiplier to a base value for that response, the multiplier being dependent on the elapsed time. In one embodiment, the multiplier is between 0 and 1. For shorter elapsed times, the multiplier will be close to 1, while for longer elapsed times, the multiplier will be close to 0. In this regard, responses with lower confidence are substantially reduced in importance, while responses with higher confidence are weighted accordingly.

A statistical analysis may then be performed to determine the assessment. The statistical analysis may be performed on the values of the responses to determine the assessment or on the elapsed times for each response.

Once the assessment has been determined, the server administering the assessment may access a database of narratives corresponding to various assessments. The narrative corresponding to the determined assessment for the subject is then selected and may be stored in memory, displayed to the subject or sent to another individual or entity through, for example, electronic mail.

In another aspect, embodiments of the present invention can provide an assessment of a relationship between two or more individuals. For example, the interaction between a husband and a wife may be assessed based on assessments of the individuals. In this regard, a variety of relationships may be addressed. In addition to spouses, for example, the relationship may be of two or more partners in a business venture, a coach and a student, or any number of other relationships. Further, this relationship assessment may be applied for specific environments for the roles. For example, a relationship assessment may be provided for a husband and a wife in a romantic environment (as a couple) or in a business environment (business partners).

In this regard, two or more subjects may be presented with an assessment as described above. Specifically, each subject is presented with a set of two or more stimuli, as shown in FIGS. 5A-C. The subject makes his selection, and the response is received by the server administering the assessment, for example. This is repeated with additional stimuli for the subject until assessments for the subject can be determined in one or more characteristic categories, or phases. The same is done for each other subject.

Now, cartelistic category assessments have been determined for each subject. For example, in the case of two subjects, Subject A and Subject B, it may be determined that Subject A is:
Strategize phase: Predominant
Motivate phase: High Select
Analyze phase: Preferred
Activate phase: High Select
   Meanwhile, Subject B has been determined to be:
Strategize phase: Predominant
Motivate phase: Low Select
Analyze phase: Preferred
Activate phase: Stressed

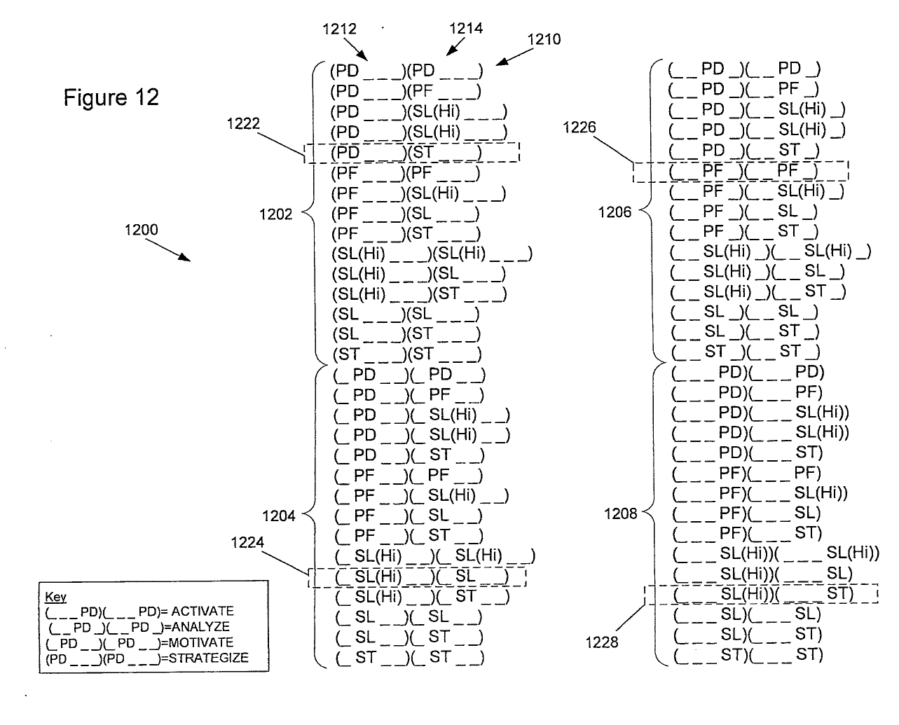

Based on these characteristic category assessments, the administering server accesses a database containing dyads and corresponding narratives. An exemplary chart of dyads is illustrated in FIG. 12. The chart 1200 lists a partial list of dyads for two-party relationships. It will be understood by those skilled in the art that such dyads may be adaptable for relationships involving any number of parties. Further, the term “dyad” is used herein in a generic manner to refer to a set of descriptors for two or more parties.

Referring now to FIG. 12, the chart 1200 includes a list of dyads, such as dyad 1210, each dyad containing two descriptors 1212, 1214. Each descriptor includes four position slots, each corresponding to a different characteristic category. For example, in the chart illustrated in FIG. 12, the first set of dyads 1202 corresponds to the Strategy phase and, accordingly, each descriptor includes an entry in the first slot. Similarly, the second set of dyads 1204 corresponds to the Motivate phase and, accordingly, each descriptor includes an entry in the second slot. The third set of dyads 1206 corresponds to the Analyze phase, and the fourth set of dyads 1208 corresponds to the Activate phase.

In the embodiment illustrated in FIG. 12, only one slot in each dyad descriptor is provided with an entry, while the other three are blank. In this manner, the relationship assessment of the relationship between the subjects is assessed using a single characteristic category assessment at a time. As those skilled in the art will understand, and as is contemplated within the scope of the present invention, a multi-dimensional assessment may be done through analysis of two or more characteristic categories at a time.

Referring again to the example of Subject A and Subject B, their characteristic category assessments can be used to select a dyad for each of the four characteristic category. With the above-described characteristic category assessments, the dyads 1222, 1224, 1226, 1228 are selected. In the database, each dyad corresponds to a narrative developed by experts. The appropriate narratives for each characteristic category can be retrieved from the database and output to the subjects, a manager or any other entity. Alternatively, they may be stored for future reference.

The narratives for the relationships provide role-specific, environment-specific descriptions of the assessments. In this regard, the database may contain separate dyads for different relationships. For example, one set of dyads may be appropriate for a manager-employee relationship, while another set may be appropriate for a mentor-mentee relationship.

The foregoing description of embodiments of the invention has been presented for purposes of illustration and description. It is not intended to be exhaustive or to limit the invention to the precise form disclosed, and modifications and variation are possible in light of the above teachings or may be acquired from practice of the invention. The embodiments were chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A system for conducting an assessment of a subject, comprising:
a server adapted to present to a subject at least one stimulus and to receive a response by said subject to each said stimulus presented, wherein said at least one stimulus is selected in real time and corresponds to a characteristic category; and
said server being further adapted to determine an assessment of said subject based on said responses;
wherein said assessment is determined based at least partly on elapsed time for said responses.

2. The system according to claim 1, wherein said assessment is determined based on comparison of elapsed time for each response to a mean elapsed time for all responses from the subject.

3. The system according to claim 1, wherein said server is adapted to assign a value to each response based on the elapsed time for that response.

4. The system according to claim 3, wherein said value is determined by applying a multiplier to a base value, the multiplier being dependent on the elapsed time.

5. The system according to claim 4, wherein said server is adapted to perform a statistical analysis on the values of the responses to determine the assessment.

6. The system according to claim 3, wherein said server is adapted to perform a statistical analysis on the values of the responses to determine the assessment.

7. The system according to claim 1, wherein said server is adapted to perform a statistical analysis on the elapsed times of the responses to determine the assessment.

8. The system according to claim 1, wherein each stimulus comprises a word-pair.

9. The system according to claim 1, further comprising:
a database of narratives corresponding to one or more assessments,
wherein said server is adapted to output a narrative from the database corresponding to the assessment determined.

10. A method of conducting an assessment of a subject, said method comprising:
a) presenting to a subject a first set of two or more stimuli, wherein at least two of said stimuli correspond to different characteristic categories;
b) receiving a selection by said subject of one of said stimuli corresponding to a first characteristic category;
c) repeating steps a) and b) as necessary with additional sets of stimuli; and
d) outputting an assessment of the subject based on said responses, wherein said assessment is determined based at least partly on elapsed time for said responses.

11. The method according to claim 10, wherein said assessment is determined based on comparison of elapsed time for each response to a mean elapsed time for all responses from the subject.

12. The method according to claim 10, further comprising:
assigning a value to each response based on the elapsed time for that response.

13. The method according to claim 12, wherein said value is determined by applying a multiplier to a base value, the multiplier being dependent on the elapsed time.

14. The method according to claim 13, wherein the assessment is determined by performing a statistical analysis on the values of the responses to determine the assessment.

15. The method according to claim 12, wherein the assessment is determined by performing a statistical analysis on the values of the responses to determine the assessment.

16. The method according to claim 10, wherein the assessment is determined by performing a statistical analysis on the elapsed times of the responses to determine the assessment.

17. The method according to claim 10, wherein each stimulus comprises a word-pair.

18. The method according to claim 10, wherein the outputting an assessment comprises:
selecting a narrative from a database of narratives corresponding to the assessment determined; and
outputting the selected narrative.

19. A program product, comprising machine readable program code for causing a machine to perform the following method steps:
a) presenting to a subject a first set of two or more stimuli, wherein at least two of said stimuli correspond to different characteristic categories;
b) receiving a selection by said subject of one of said stimuli corresponding to a first characteristic category;
c) repeating steps a) and b) as necessary with additional sets of stimuli; and
d) outputting an assessment of the subject based on said responses, wherein said assessment is determined based at least partly on elapsed time for said responses.

20. The program product according to claim 19, wherein said assessment is determined based on comparison of elapsed time for each response to a mean elapsed time for all responses from the subject.

21. The program product according to claim 19, further comprising machine readable program code for causing a machine to perform the following method step:
assigning a value to each response based on the elapsed time for that response.

22. The program product according to claim 21, wherein said value is determined by applying a multiplier to a base value, the multiplier being dependent on the elapsed time.

23. The program product according to claim 22, wherein the assessment is determined by performing a statistical analysis on the values of the responses to determine the assessment.

24. The program product according to claim 21, wherein the assessment is determined by performing a statistical analysis on the values of the responses to determine the assessment.

25. The program product according to claim 19, wherein the assessment is determined by performing a statistical analysis on the elapsed times of the responses to determine the assessment.

26. The program product according to claim 19, wherein each stimulus comprises a word-pair.

27. The program product according to claim 19, wherein the machine readable program code for causing a machine to perform the outputting an assessment comprises machine readable program code for causing a machine to perform the following steps:
selecting a narrative from a database of narratives corresponding to the assessment determined; and
outputting the selected narrative.

28. A system for conducting a relationship assessment of two or more subjects, comprising:
a server adapted to present to each subject at least one stimulus and to receive a response by each subject to each stimulus presented, wherein said at least one stimulus is selected in real time and corresponds to a characteristic category, said server being further adapted to determine a characteristic category assessment of each subject based on said responses for one or more characteristic categories; and
a database of dyads, each dyad based on a characteristic category assessment of each subject and corresponding to a relationship assessment of a relationship between the subjects.

29. The system according to claim 28, wherein each stimulus comprises a word-pair.

30. The system according to claim 28, wherein the database of dyads includes narratives corresponding to one or more relationship assessments, and
wherein said server is adapted to output a narrative from the database corresponding to the relationship assessment.

31. The system according to claim 28, wherein each dyad includes a characteristic category assessment for at least one of the following characteristic categories: strategize, motivate, analyze and activate.

32. A method of conducting a relationship assessment of two or more subjects, said method comprising:
a) presenting to a subject a first set of two or more stimuli, wherein at least two of said stimuli correspond to different characteristic categories;
b) receiving a selection by said subject of one of said stimuli corresponding to a first characteristic category;
c) repeating steps a) and b) as necessary with additional sets of stimuli;
d) determining a characteristic category assessment of the subject based on said responses for one or more characteristic categories;
e) repeating steps a)-d) for each remaining subject; and
f) outputting a relationship assessment of a relationship between the subjects based on the characteristic category assessments determined for each subject.

33. The method according to claim 32, wherein each stimulus comprises a word-pair.

34. The method according to claim 32, wherein the outputting a relationship assessment comprises:
selecting a dyad from a database of dyads including narratives corresponding to one or more relationship assessments, and
outputting a narrative from the database corresponding to the relationship assessment.

35. The method according to claim 34, wherein each dyad includes a characteristic category assessment for at least one of the following characteristic categories: strategize, motivate, analyze and activate.

36. A program product, comprising machine readable program code for causing a machine to perform the following method steps:
a) presenting to a subject a first set of two or more stimuli, wherein at least two of said stimuli correspond to different characteristic categories;
b) receiving a selection by said subject of one of said stimuli corresponding to a first characteristic category;
c) repeating steps a) and b) as necessary with additional sets of stimuli;
d) determining a characteristic category assessment of the subject based on said responses for one or more characteristic categories;
e) repeating steps a)-d) for each remaining subject; and
f) outputting a relationship assessment of a relationship between the subjects based on the characteristic category assessments determined for each subject.

37. The program product according to claim 36, wherein each stimulus comprises a word-pair.

38. The program product according to claim 36, wherein the machine readable program code for causing a machine to perform the outputting a relationship assessment comprises machine readable program code for causing a machine to perform the following method steps:
selecting a dyad from a database of dyads including narratives corresponding to one or more relationship assessments, and
outputting a narrative from the database corresponding to the relationship assessment.

39. The program product according to claim 36, wherein each dyad includes a characteristic category assessment for at least one of the following characteristic categories: strategize, motivate, analyze and activate.

40. A method of conducting an assessment of a subject, comprising:
a) presenting to said subject a first set of two or more stimuli, wherein at least two of said stimuli correspond to different characteristic categories; and
b) receiving a selection by said subject of one of said stimuli corresponding to a first characteristic category.

41. The method according to claim 40, wherein three or more stimuli are presented in step a).

42. The method according to claim 40, wherein four or more stimuli are presented in step a).

43. The method according to claim 40, wherein more than four stimuli are presented in step a).

44. The method according to claim 40, further comprising
presenting four stimuli in step a), wherein each said different characteristic category corresponds to a different phase in a success/satisfaction cycle.

45. The method according to claim 40, further comprising
presenting an inquiry to said subject in step a), and receiving a selection by said subject in response to said inquiry in step b).

46. The method according to claim 40, further comprising:
c) presenting to said subject a second set of two or more stimuli corresponding to characteristic categories different from said first characteristic category; and
d) receiving a selection by said subject of one of said second set of two or more stimuli corresponding to a second characteristic category.

47. The method according to claim 46, further comprising:
e) presenting to said subject a third set of two or more stimuli corresponding to characteristic categories different from said first and second characteristic categories; and
f) receiving a selection by said subject of one of said third set of two or more stimuli corresponding to a third characteristic category.

48. The method of claim 47, further comprising
obtaining an order of selection of said characteristic categories.

49. The method according to claim 48, further comprising
repeating steps a) to f) with additional sets of stimuli.

50. The method according to claim 40, wherein said receiving further comprises a response time criterion.

51. The method according to claim 50, wherein said response time criterion is in the range 1-45 seconds.

52. The method according to claim 40, wherein step a) to b) further comprise communication with said subject through a network.

53. The method according to claim 52, wherein said network is the Internet.

54. The method according to claim 40, wherein each stimulus comprises a word-pair.

55. A method of conducting an assessment of a subject, comprising:
a) presenting to said subject two to four stimuli and an inquiry, wherein each stimulus corresponds to a phase in a success/satisfaction cycle;
b) receiving a selection by said subject of one of said stimuli in response to said inquiry; and
c) repeating steps a) and b) until an order of selection of each said phase is determined.

56. The method of claim 55, further comprising:
d) processing said order of selection to determine an assessment of said subject.

57. The method according to claim 55, wherein each stimulus comprises a word-pair.

58. The method according to claim 55, wherein said receiving further comprises a response time criterion.

59. The method according to claim 58, wherein said response time criterion is in the range 1-45 seconds.

60. A program product, comprising machine readable program code for causing a machine to perform the following method steps:
a) presenting to said subject a first set of two or more stimuli, wherein at least two of said stimuli correspond to different characteristic categories; and
b) receiving a selection by said subject of one of said stimuli corresponding to a first characteristic category.

61. The program product according to claim 60, further comprising machine readable program code for causing a machine to present four stimuli in step a), wherein each said different characteristic category corresponds to a different phase in a success/satisfaction cycle.

62. The program product according to claim 60, further comprising machine readable program code for causing a machine to present an inquiry to said subject in step a), and receive a selection by said subject in response to said inquiry in step b).

63. The program product according to claim 60, further comprising machine readable program code for causing a machine to perform the following method steps:
c) presenting to said subject a second set of two or more stimuli corresponding to characteristic categories different from said first characteristic category; and
d) receiving a selection by said subject of one of said second set of two or more stimuli corresponding to a second characteristic category.

64. The program product according to claim 63, further comprising machine readable program code for causing a machine to perform the following method steps:
e) presenting to said subject a third set of two or more stimuli corresponding to characteristic categories different from said first and second characteristic categories; and
f) receiving a selection by said subject of one of said third set of two or more stimuli corresponding to a third characteristic category.

65. The program product according to claim 64, further comprising machine readable program code causing a machine to obtain an order of selection of said characteristic categories.

66. The program product according to claim 65, further comprising machine readable program code for causing a machine to repeat steps a) to f) with additional sets of stimuli.

67. The program product according to claim 60, wherein step a) to b) further comprise communication with said subject through a network.

68. The program product according to claim 67, wherein said network is the Internet.

69. The program product according to claim 60, wherein each stimulus comprises a word-pair.

70. A program product, comprising machine readable program code for causing a machine to perform the following method steps:
a) presenting to said subject two to four stimuli and an inquiry, wherein each stimulus corresponds to a phase in a success/satisfaction cycle;
b) receiving a selection by said subject of one of said stimuli in response to said inquiry; and
c) repeating steps a) and b) until an order of selection of each said phase is determined.

71. The program product of claim 70, further comprising machine readable program code for causing a machine to perform the following method step:
d) processing said order of selection to determine an assessment of said subject.

72. The program product according to claim 70, wherein each stimulus comprises a word-pair.

73. A system for conducting an assessment of a subject, comprising:
a server adapted to present two or more stimuli to said subject on a computer, each said stimulus corresponding to a different characteristic category;
said server being further adapted to receive a selection by said subject of one of said stimuli.

74. The system according to claim 73, wherein each stimulus comprises a word-pair.

75. A computer-implemented method of evaluating an assessment of a subject, comprising:
a) presenting to said subject at least one stimulus, wherein said at least one stimulus is selected in real time and corresponds to a characteristic category; and
b) evaluating said assessment of said subject based on a response received from said subject to each said stimulus presented.

76. The method according to claim 75, wherein step a) further comprises randomly selecting said at least one stimulus from a database of stimuli.

77. The method according to claim 75, wherein said stimulus is a word-pair.

78. The method according to claim 75, wherein step a) further comprises formulating an entire assessment by selecting a plurality of stimuli.

79. The method according to claim 78, wherein said plurality of stimuli comprise at least one stimulus corresponding to each of a plurality of different said characteristic categories.

80. The method according to claim 75, further comprising:
c) determining whether said assessment evaluated in step b) requires refinement between two or more said characteristic categories.

81. The method according to claim 80, further comprising:
d) presenting an additional stimulus corresponding to each of said two or more said characteristic categories.

82. The method according to claim 81, further comprising:
e) repeating steps b) to d) until a desired level of refinement is achieved.

83. The method according to claim 80, further comprising:
d) presenting to said subject two or more stimuli, wherein each stimulus corresponds to a different said characteristic category;
e) receiving a selection by said subject of one of said stimuli; and
f) repeating steps d) and e) to obtain an order of selection of each said different characteristic categories.

84. The method according to claim 83, further comprising:
g) repeating steps c) to f) until a desired level of refinement is achieved.

85. The method according to claim 75, wherein said response received from said subject further comprises a response time criterion.

86. The method according to claim 85, wherein said response time criterion is in the range 1-45 seconds.

87. A program product, comprising machine readable program code for causing a machine to perform the following method steps:
a) presenting, when an assessment of a subject requires refinement between two or more characteristic categories of the assessment, to a subject a first set of three or more stimuli, wherein each stimulus in said first set of three or more stimuli corresponds to a different characteristic category;
b) receiving a selection by said subject of one of said stimuli;
c) presenting to said subject a second set of two or more stimuli, wherein each stimulus of said second set of two or more stimuli corresponds to a different characteristic category; and
d) repeating steps b) and c) to obtain an order of selection of each of the different characteristic categories.

88. A method of conducting an assessment of a team comprised of members, said method comprising:
a) providing the process maps of said members of said team;
b) overlaying said process maps of said members of said team; and
c) assessing said team by providing a process map comprising said overlaid process maps of said members of said team.

89. The method of claim 88, further comprising constructing a process map of a virtual member of said team, said method comprising:
d) identifying deficiencies or excesses in each characteristic category of said team assessment; and
e) constructing said process map of said virtual member of said team by ascribing to each said characteristic category of said process map of said virtual member of said team a value which compensates for said deficiencies or excesses of said overlaid process maps of said members of said team.

90. The method of claim 89 wherein said virtual member of said team fulfills a specific role or relationship within the team.

91. The method of claim 90, further comprising identifying candidate team members, said method comprising:
f) comparing said process map of said virtual member of said team with a plurality of stored assessment data obtained for candidate team members;
g) identifying a match between said virtual team member process map with said stored assessment data; and
h) identifying the candidate team member associated with said stored assessment data.

92. A system for conducting an assessment of a subject, comprising:
a server adapted to present to a subject at least one stimulus and to receive a response by said subject to each said stimulus presented, wherein said at least one stimulus is selected in real time and corresponds to a characteristic category; and
said server being further adapted to determine an assessment of said subject based on said responses.

93. The system according to claim 92, wherein said server is further adapted to determine whether said assessment requires refinement between two or more of said characteristic categories, and wherein said server is further adapted to present, when said refinement is required, an additional stimulus corresponding to each of said two or more said characteristic categories.

94. A method for coaching a client by a coach, comprising:
a) evaluating a client current process map to provide a client evaluation; and
b) reciting said client evaluation to said client.

95. The method according to claim 94, further comprising
comparing said client current process map and a coach process map to provide a coach/client evaluation to determine how said client and said coach would naturally prefer to work together.

96. The method according to claim 95, further comprising
reciting to said client said coach/client evaluation.

97. The method according to claim 95, further comprising
reciting to said client changes in the behavior of said client and said coach to improve a coach/client relationship.

98. The method according to claim 95, further comprising
reciting to said client the learning report of said client and the teaching report of said coach.

99. The method according to claim 98, further comprising
reciting to said client changes in said learning style of said client and said teaching style of said coach to achieve more efficient task completion of said client.

100. The method according to claim 94, further comprising
comparing said client current process map and a client aspiration map to provide an ideal client evaluation.

101. The method according to claim 100, further comprising
reciting to said client said ideal client evaluation.

102. The method according to claim 100, further comprising
reciting to said client changes to the behavior of said client to minimize the difference between said client current process map and said client ideal process map.

103. The method according to claim 94, further comprising
comparing said client current process map and a colleague process map to provide a colleague/client evaluation to determine how said client and said colleague prefer to work as a team.

104. The method according to claim 103, further comprising
reciting to said client said colleague/client evaluation.

105. The method according to claim 103, further comprising
reciting to said client changes in the behavior of said client and said colleague to increase success and satisfaction in the fulfillment of a task by said client and said colleague.

106. The method according to claim 94, further comprising
comparing said client current process map and a task/project process map to provide a task/client evaluation.

107. The method according to claim 106, further comprising
reciting to said client said task/client evaluation.

108. The method according to claim 106, further comprising
reciting to said client changes to the behavior of said client to minimize the difference in energy levels between said client current process map and said task/project process map.

109. The method according to claim 94, further comprising
reciting to said client the working preferences of said client.

110. The method according to claim 94, further comprising
reciting to said client the learning preferences of said client.

111. The method according to claim 94, further comprising
visualization of how said client prefers to spend time on a task.

112. The method according to claim 94, further comprising
visualization of how said client prefers to spend focused energy on a task.

113. The method according to claim 95, further comprising
incorporating said client evaluation and said coach/client evaluation within an archive database.

114. The method according to claim 113, further comprising
annotating responses of said coach and said client within an archive database.

115. The method according to claim 113, further comprising
receiving editing feedback by the client prior to entry of said client evaluation into said archive database.

116. The method according to claim 113, further comprising
reviewing said archive database by said coach and said client to identify success and failure in a coach-client relationship.

117. The method according to claim 115, further comprising
repeating steps a) and b) and comparing said client evaluation with said client evaluation within said archive database to provide an updated client evaluation.

118. A program product, comprising machine readable program code for causing a machine to evaluate a client current process map to provide a client evaluation.

119. The program product according to claim 118,
further comprising machine readable program code for causing a machine to compare said client current process map and a coach process map to provide a coach/client evaluation.

120. The program product according to claim 118,
further comprising machine readable program code for causing a machine to compare said client current process map and a client aspiration map to provide an ideal client evaluation.

121. The program product according to claim 118,
further comprising machine readable program code for causing a machine to compare said client current process map and a colleague process map to provide a colleague/client evaluation.

122. The program product according to claim 118,
further comprising machine readable program code for causing a machine to compare said client current process map and a task/project process map to provide a task/client evaluation.
